(19) United States
(12) Patent Application Publication
(10) Pub. No.: US 2026/0222106 A1
(43) Pub. Date: Jul. 30, 2026

(54) SYSTEM AND METHODS FOR ENCODING PHYSICAL LAYER HEADER IN WIRELESS COMMUNICATION

(71) Applicant: Qorvo US, Inc., Greensboro, NC (US)

(72) Inventors: Carl Murray, Dublin (IE); Jaroslaw Niewczas, Józefów (PL); Billy Verso, Maynooth (IE)

(21) Appl. No.: 19/144,270

(22) PCT Filed: Nov. 22, 2023
(86) PCT No.: PCT/US2023/080941

§ 371 Date: Jun. 27, 2025

Related U.S. Application Data
(60) Provisional application No. 63/480,087, filed on Jan. 16, 2023.

(51) Int. Cl. H04L 1/00

(52) U.S. Cl. CPC H04L 1/0003; H04L 1/0033

(57) ABSTRACT

A method for processing a data packet in wireless communication is provided. The method includes: storing a plurality of bit sequences of non-uniform Hamming distance from one another, the plurality of bit sequences each corresponding to a respective set of modulation rate and coding scheme for transmitting a set of modulated data; receiving a set of information bits corresponding to a first part of the set of modulated data, the set of information bits indicating a modulation rate and a coding scheme of a second part of the set of modulated data; and mapping the modulation rate and coding scheme of the second part of the set of modulated data to one of the plurality of bit sequences. The method also includes transmitting a mapped bit sequence as the first part of the set of modulated data.

### CROSS-REFERENCE TO RELATED APPLICATIONS

The present application claims the benefit of U.S. Provisional Application No. 63/480,087, filed Jan. 16, 2023, which is incorporated herein by reference in its entirety.

### FIELD OF THE DISCLOSURE

The present disclosure relates to wireless communication, in particular, to a system and methods for encoding physical layer header (PHR) in wireless communication.

### BACKGROUND

Ultra-wideband (UWB) is a wireless communication technology that uses a wide bandwidth, typically about 500 MHz or larger, or has a 10 dB bandwidth greater than 20% of the center frequency. The communication between UWB devices often include the transmission of data packets or frames. A physical layer (PHY) data packet can include data encoded as modulated signals. A data packet may include a physical layer header (PHR). The main function of the PHR in the UWB radio is to indicate the length of PHY data payload following it. It may also indicate other features of the modulation to be used for the PHY data payload, such as the modulation/data rate of the PHY data payload. While the PHR is often transmitted as a lower modulation/data rate, the data rate of the payload is much higher. The difference between PHR modulation/data rate and the PHY payload modulation/data rate can be so much that there is a penalty on the packet durations of the otherwise high-rate packets, e.g., having to send the PHR at the lowest modulation rate. Thus, the processing, e.g., encoding, of the PHR needs to be improved to accommodate the low modulation/data rate of the PHR and higher modulation/data rate of the PHY payload without increasing packet duration significantly.

### SUMMARY

Embodiments of the disclosure provide a method for processing a data packet in wireless communication. The method includes: storing a plurality of bit sequences of non-uniform Hamming distance from one another having non-uniform Hamming distances to other bit sequences, the plurality of bit sequences each corresponding to a respective set of modulation rate and coding scheme for transmitting a set of modulated data; receiving a set of information bits corresponding to a first part of the set of modulated data, the set of information bits indicating a modulation rate and a coding scheme of a second part of the set of modulated data; mapping the modulation rate and coding scheme of the second part of the set of modulated data to one of the plurality of bit sequences; and transmitting a mapped bit sequence as the first part of the set of modulated data.

In some embodiments, the method further includes transmitting the second part of the set of modulated data at the respective modulation rate and coding scheme indicated by the mapped bit sequence.

In some embodiments, the first part of the set of modulated data comprises a first part of a physical layer header (PHR1).

In some embodiments, the second part of the set of modulated data comprises one of a second part of a physical layer header (PHR2), or a data payload.

In some embodiments, the non-uniform Hamming distance corresponds to a coding strength of the mapped bit sequence from the plurality of bit sequences and is related to a minimum of Hamming distances between the mapped bit sequence and remaining bit sequences of the plurality of bit sequences.

In some embodiments, a first minimum Hamming distance of a first bit sequence is different than a second minimum Hamming distance of a second bit sequence, of the plurality of bit sequences.

In some embodiments, the first minimum Hamming distance of the first bit sequence is at least 13.

In some embodiments, the second minimum Hamming distance of the second bit sequence is at least 8.

In some embodiments, the modulation rate of the second part of the set of modulated data indicated by the first bit sequence is lower than or equal to modulation rates indicated by the second bit sequence.

In some embodiments, the plurality of bit sequences includes: 1 1 1 1 1 1 1 1 1 1 1 1 1 1 1 1 1 1 1 1, 0 0 0 0 0 1 0 0 1 1 0 0 1 1 0 0 1 1 0 0, 0 0 0 0 0 0 0 1 1 0 0 1 1 0 0 1 1 0 0 1, 0 0 0 0 0 1 1 1 0 0 0 0 1 1 1 1 0 0 0 0, 0 0 0 0 0 0 1 0 0 1 0 1 1 0 1 0 0 1 0 1, 0 0 0 0 0 1 0 0 0 0 1 1 1 1 0 0 0 0 1 1, 0 0 0 0 0 0 0 1 0 1 1 0 1 0 0 1 0 1 1 0, 0 0 0 0 0 1 1 1 1 1 1 1 0 0 0 0 0 0 0 0, 0 0 0 0 0 0 1 0 1 0 1 0 0 1 0 1 0 1 0 1, 0 0 0 0 0 1 0 0 1 1 0 0 0 0 1 1 0 0 1 1, 1 1 1 1 1 0 0 0 0 0 0 0 0 0 0 0 0 0 0 0, 0 0 0 0 0 0 0 1 1 0 0 1 0 1 1 0 0 1 1 0, 0 0 0 0 0 1 1 1 0 0 0 0 0 0 0 0 1 1 1 1, 0 0 0 0 0 0 1 0 0 1 0 1 0 1 0 1 1 0 1 0, 0 0 0 0 0 1 0 0 0 0 1 1 0 0 1 1 1 1 0 0, or 0 0 0 0 0 0 0 1 0 1 1 0 0 1 1 0 1 0 0 1.

In some embodiments, the plurality of bit sequences are modified by changing an order of the rows of the plurality of bit sequences or changing an order of the columns of the plurality of bit sequences.

In some embodiments, the plurality of bit sequences includes: 0 0 0 0 0 0 0 0 0 0 0 0 0 0 0 0 0 0 0 0, 1 1 1 1 1 0 1 1 0 0 1 1 0 0 1 1 0 0 1 1, 1 1 1 1 1 1 1 0 0 1 1 0 0 1 1 0 0 1 1 0, 1 1 1 1 1 0 0 0 1 1 1 1 0 0 0 0 1 1 1 1, 1 1 1 1 1 1 0 1 1 0 1 0 0 1 0 1 1 0 1 0, 1 1 1 1 1 0 1 1 1 1 0 0 0 0 1 1 1 1 0 0, 1 1 1 1 1 1 1 0 1 0 0 1 0 1 1 0 1 0 0 1, 1 1 1 1 1 0 0 0 0 0 0 0 1 1 1 1 1 1 1 1, 1 1 1 1 1 1 0 1 0 1 0 1 1 0 1 0 1 0 1 0, 1 1 1 1 1 0 1 1 0 0 1 1 1 1 0 0 1 1 0 0, 0 0 0 0 0 1 1 1 1 1 1 1 1 1 1 1 1 1 1 1, 1 1 1 1 1 1 1 0 0 1 1 0 1 0 0 1 1 0 0 1, 1 1 1 1 1 0 0 0 1 1 1 1 1 1 1 1 0 0 0 0, 1 1 1 1 1 1 0 1 1 0 1 0 1 0 1 0 0 1 0 1, 1 1 1 1 1 0 1 1 1 1 0 0 1 1 0 0 0 0 1 1, or 1 1 1 1 1 1 1 0 1 0 0 1 1 0 0 1 0 1 1 0.

Another aspect of the present disclosure provides a ultra-wideband (UWB) device. The UWB device includes a transceiver operable to perform UWB communication, and a memory for storing program instructions and a plurality of bit sequences of non-uniform Hamming distance. Each of the plurality of bit sequences corresponds to a set of modulation rate and coding scheme for transmitting a set of modulated data. The UWB device also includes a processor coupled to the transceiver and to the memory. The processor is operable to execute the program instructions, which, when executed by the processor, cause the UWB device to perform the following operations. The operations include storing a plurality of bit sequences of non-uniform Hamming distance from one another, the plurality of bit sequences each corresponding to a respective set of modulation rate and coding scheme for transmitting a set of modulated data; receiving a set of information bits corresponding to a first part of the set of modulated data, the set of information bits indicating a modulation rate and a coding scheme of a second part of the set of modulated data; mapping the modulation rate and coding scheme of the second part of the set of modulated data to one of the plurality of bit sequences; and transmitting a mapped bit sequence as the first part of the set of modulated data.

In some embodiments, the UWB device further includes transmitting the second part of the set of modulated data at the respective modulation rate and coding scheme indicated by the mapped bit sequence.

In some embodiments, the first part of the set of modulated data comprises a first part of a physical layer header (PHR1).

In some embodiments, the second part of the set of modulated data comprises one of a second part of a physical layer header (PHR2), or a data payload.

In some embodiments, the non-uniform Hamming distance corresponds to a coding strength of the mapped bit sequence from the plurality of bit sequences and is related to a minimum of Hamming distances between the mapped bit sequence and remaining bit sequences of the plurality of bit sequences.

In some embodiments, a first minimum Hamming distance of a first bit sequence is different than a second minimum Hamming distance of a second bit sequence, of the plurality of bit sequences.

In some embodiments, the first minimum Hamming distance of the first bit sequence is at least 13.

In some embodiments, the second minimum Hamming distance of the second bit sequence is at least 8.

In some embodiments, the modulation rate of the second part of the set of modulated data indicated by the first bit sequence is lower than or equal to modulation rates indicated by the second bit sequence.

In some embodiments the plurality of bit sequences include: 1 1 1 1 1 1 1 1 1 1 1 1 1 1 1 1 1 1 1 1, 0 0 0 0 0 1 0 0 1 1 0 0 1 1 0 0 1 1 0 0, 0 0 0 0 0 0 0 1 1 0 0 1 1 0 0 1 1 0 0 1, 0 0 0 0 0 1 1 1 0 0 0 0 1 1 1 1 0 0 0 0, 0 0 0 0 0 0 1 0 0 1 0 1 1 0 1 0 0 1 0 1, 0 0 0 0 0 1 0 0 0 0 1 1 1 1 0 0 0 0 1 1, 0 0 0 0 0 0 0 1 0 1 1 0 1 0 0 1 0 1 1 0, 0 0 0 0 0 1 1 1 1 1 1 1 0 0 0 0 0 0 0 0, 0 0 0 0 0 0 1 0 1 0 1 0 0 1 0 1 0 1 0 1, 0 0 0 0 0 1 0 0 1 1 0 0 0 0 1 1 0 0 1 1, 1 1 1 1 1 0 0 0 0 0 0 0 0 0 0 0 0 0 0 0, 0 0 0 0 0 0 0 1 1 0 0 1 0 1 1 0 0 1 1 0, 0 0 0 0 0 1 1 1 0 0 0 0 0 0 0 0 1 1 1 1, 0 0 0 0 0 0 1 0 0 1 0 1 0 1 0 1 1 0 1 0, 0 0 0 0 0 1 0 0 0 0 1 1 0 0 1 1 1 1 0 0, or 0 0 0 0 0 0 0 1 0 1 1 0 0 1 1 0 1 0 0 1.

In some embodiments, the plurality of bit sequences are modified by changing an order of the rows of the plurality of bit sequences or changing an order of the columns of the plurality of bit sequences.

In some embodiments, the plurality of bit sequences include: 0 0 0 0 0 0 0 0 0 0 0 0 0 0 0 0 0 0 0 0, 1 1 1 1 1 0 1 1 0 0 1 1 0 0 1 1 0 0 1 1, 1 1 1 1 1 1 1 0 0 1 1 0 0 1 1 0 0 1 1 0, 1 1 1 1 1 0 0 0 1 1 1 1 0 0 0 0 1 1 1 1, 1 1 1 1 1 0 1 1 0 1 0 0 1 0 1 1 0 1 0, 1 1 1 1 1 0 1 1 1 1 0 0 0 0 1 1 1 1 0 0, 1 1 1 1 1 1 1 0 1 0 0 1 0 1 1 0 1 0 0 1, 1 1 1 1 1 0 0 0 0 0 0 0 1 1 1 1 1 1 1 1, 1 1 1 1 1 1 0 1 0 1 0 1 1 0 1 0 1 0 1 0, 1 1 1 1 1 0 1 1 0 0 1 1 1 1 0 0 1 1 0 0, 0 0 0 0 0 1 1 1 1 1 1 1 1 1 1 1 1 1 1 1, 1 1 1 1 1 1 1 0 0 1 1 0 1 0 0 1 1 0 0 1, 1 1 1 1 1 0 0 0 1 1 1 1 1 1 1 1 1 0 0 0 1 0, 1 1 1 1 1 0 1 1 0 1 0 1 0 1 0 0 1 0 1, 1 1 1 1 1 0 1 1 1 1 0 0 1 1 0 0 0 0 1 1, or 1 1 1 1 1 1 1 0 1 0 0 1 1 0 0 1 0 1 1 0.

Another aspect of the present disclosure provides a method for processing a data packet in wireless communication. The method includes: receiving a set of information bits corresponding to a modulation rate and a coding scheme of a set of modulated data; mapping the modulation rate and coding scheme of the set of modulated data to one of a plurality of bit Sequences; and transmitting a mapped bit sequence as a first part of the set of modulated data. The plurality of bit sequence includes one of: 1 1 1 1 1 1 1 1 1 1 1 1 1, 0 0 0 0 0 1 0 0 1 1 0 0 1 1 0 0 1 1 0 0, 0 0 0 0 0 0 0 1 1 0 0 1 1 0 0 1 1 0 0 1, 0 0 0 0 0 1 1 1 0 0 0 0 1 1 1 1 0 0 0 0, 0 0 0 0 0 0 1 0 0 1 0 1 1 0 1 0 0 1 0 1, 0 0 0 0 0 1 0 0 0 0 1 1 1 1 0 0 0 0 1 1, 0 0 0 0 0 0 0 1 0 1 1 0 1 0 0 1 0 1 1 0, 0 0 0 0 0 1 1 1 1 1 1 1 0 0 0 0 0 0 0 0, 0 0 0 0 0 0 1 0 1 0 1 0 0 1 0 1 0 1 0 1, 0 0 0 0 0 1 0 0 1 1 0 0 0 0 1 1 0 0 1 1, 1 1 1 1 1 0 0 0 0 0 0 0 0 0 0 0 0 0 0 0, 0 0 0 0 0 0 0 1 1 0 0 1 0 1 1 0 0 1 1 0 0 0 0 0 0 1 1 1 0 0 0 0 0 0 0 0 1 1 1 1, 0 0 0 0 0 0 1 0 0 1 0 1 0 1 0 1 1 0 1 0, 0 0 0 0 0 1 0 0 0 0 1 1 0 0 1 1 1 1 0 0, or 0 0 0 0 0 0 0 1 0 1 1 0 0 1 1 0 1 0 0 1.

Another aspect of the present disclosure provides a method for processing a data packet in wireless communication. The method includes: storing a plurality of bit sequences of non-uniform Hamming distance, the plurality of bit sequences each corresponding to a respective set of modulation rate and coding scheme for transmitting a set of modulated data; receiving a first part of the set of modulated data, the first part of the set of modulated data comprising a sample sequence that indicates a modulation rate and coding scheme of a second part of set of modulated data; and decoding the first part of the set of modulated data. The decoding includes: selecting one of the plurality of bit sequences that corresponds to the sample sequence; and determining the modulation rate and coding scheme of the second part of the set of modulated data to be a modulation rate indicated by a mapped bit sequence.

In some embodiments, the method further includes transmitting the second part of the set of modulated data at the respective modulation rate and coding scheme indicated by the mapped bit sequence.

In some embodiments, the first part of the set of modulated data comprises a first part of a physical layer header (PHR1).

In some embodiments, the second part of the set of modulated data comprises one of a second part of a physical layer header (PHR2), or a data payload.

In some embodiments, the non-uniform Hamming distance corresponds to a coding strength of the mapped bit sequence from the plurality of bit sequences and is related to a minimum of Hamming distances between the mapped bit sequence and remaining bit sequences of the plurality of bit sequences.

In some embodiments, a first minimum Hamming distance of a first bit sequence is different than a second minimum Hamming distance of a second bit sequence, of the plurality of bit sequences.

In some embodiments, the first minimum Hamming distance of the first bit sequence is at least 13.

In some embodiments, the second minimum Hamming distance of the second bit sequence is at least 8.

In some embodiments, the modulation rate of the second part of the set of modulated data indicated by the first bit sequence is lower than or equal to modulation rates indicated by the second bit sequence.

In some embodiments, the plurality of bit sequences include: 1 1 1 1 1 1 1 1 1 1 1 1 1 1 1 1 1 1 1 1, 0 0 0 0 0 1 0 0 1 1 0 0 1 1 0 0 1 1 0 0, 0 0 0 0 0 0 0 1 1 0 0 1 1 0 0 1 1 0 0 1, 0 0 0 0 0 1 1 1 0 0 0 0 1 1 1 1 0 0 0 0, 0 0 0 0 0 0 1 0 0 1 0 1 1 0 1 0 0 1 0 1, 0 0 0 0 0 1 0 0 0 0 1 1 1 1 0 0 0 0 1 1, 0 0 0 0 0 0 0 1 0 1 1 0 1 0 0 1 0 1 1 0, 0 0 0 0 0 1 1 1 1 1 1 1 0 0 0 0 0 0 0 0, 0 0 0 0 0 0 1 0 1 0 1 0 0 1 0 1 0 1 0 1, 0 0 0 0 0 1 0 0 1 1 0 0 0 0 1 1 0 0 1 1, 1 1 1 1 1 0 0 0 0 0 0 0 0 0 0 0 0 0 0 0, 0 0 0 0 0 0 0 1 1 0 0 1 0 1 1 0 0 1 1 0, 0 0 0 0 0 1 1 1 0 0 0 0 0 0 0 0 1 1 1 1, 0 0 0 0 0 0 1 0 0 1 0 1 0 1 0 1 1 0 1 0, 0 0 0 0 0 1 0 0 0 0 1 1 0 0 1 1 1 1 0 0, or 0 0 0 0 0 0 0 1 0 1 1 0 0 1 1 0 1 0 0 1.

In some embodiments, the plurality of bit sequences are modified by changing an order of the rows of the plurality of bit sequences or changing an order of the columns of the plurality of bit sequences.

In some embodiments, the plurality of bit sequences include: 0 0 0 0 0 0 0 0 0 0 0 0 0 0 0 0 0 0 0 0, 1 1 1 1 1 0 1 1 0 0 1 1 0 0 1 1 0 0 1 1, 1 1 1 1 1 1 1 0 0 1 1 0 0 1 1 0 0 1 1 0, 1 1 1 1 1 0 0 0 1 1 1 1 0 0 0 0 1 1 1 1, 1 1 1 1 1 1 0 1 1 0 1 0 0 1 0 1 1 0 1 0, 1 1 1 1 1 0 1 1 1 1 0 0 0 0 1 1 1 1 0 0, 1 1 1 1 1 1 1 0 1 0 0 1 0 1 1 0 1 0 0 1, 1 1 1 1 1 0 0 0 0 0 0 0 1 1 1 1 1 1 1 1, 1 1 1 1 1 1 0 1 0 1 0 1 1 0 1 0 1 0 1 0, 1 1 1 1 1 0 1 1 0 0 1 1 1 1 0 0 1 1 0 0, 0 0 0 0 0 1 1 1 1 1 1 1 1 1 1 1 1 1 1 1, 1 1 1 1 1 1 1 0 0 1 1 0 1 0 0 1 1 0 0 1, 1 1 1 1 1 0 0 0 1 1 1 1 1 1 1 1 0 0 0 0, 1 1 1 1 1 1 0 1 1 0 1 0 1 0 1 0 0 1 0 1, 1 1 1 1 1 0 1 1 1 1 0 0 1 1 0 0 0 0 1 1, or 1 1 1 1 1 1 1 0 1 0 0 1 1 0 0 1 0 1 1 0.

Another aspect of the present disclosure provides an ultra-wideband (UWB) device. The UWB device includes a transceiver operable to perform a UWB communication and a memory for storing program instructions and a plurality of bit sequences of non-uniform coding strength. Each of the plurality of bit sequences corresponds to a set of modulation rate and coding scheme for transmitting a set of modulated data. The UWB device also includes a processor coupled to the transceiver and to the memory. The processor is operable to execute the program instructions, which, when executed by the processor, cause the UWB device to perform the following operations. The operations include: receiving a first part of the set of modulated data, the first part of the set of modulated data comprising a sample sequence that indicates a modulation rate and coding scheme of a second part of set of modulated data; and decoding the first part of the set of modulated data. The decoding includes: selecting one of the plurality of bit sequences that corresponds to the sample sequence; and determining the modulation rate and coding scheme of the second part of the set of modulated data to be a modulation rate indicated by a mapped bit sequence.

In some embodiments, the UWB device further includes transmitting the second part of the set of modulated data at the respective modulation rate and coding scheme indicated by the mapped bit sequence.

In some embodiments, the first part of the set of modulated data comprises a first part of a physical layer header (PHR1).

In some embodiments, the second part of the set of modulated data comprises one of a second part of a physical layer header (PHR2), or a data payload.

In some embodiments, the non-uniform Hamming distance corresponds to a coding strength of the mapped bit sequence from the plurality of bit sequences and is related to a minimum of Hamming distances between the mapped bit sequence and remaining bit sequences of the plurality of bit sequences.

In some embodiments, a first minimum Hamming distance of a first bit sequence is different than a second minimum Hamming distance of a second bit sequence, of the plurality of bit sequences.

In some embodiments, the first minimum Hamming distance of the first bit sequence is at least 13.

In some embodiments, the second minimum Hamming distance of the second bit sequence is at least 8.

In some embodiments, the modulation rate of the second part of the set of modulated data indicated by the first bit sequence is lower than or equal to modulation rates indicated by the second bit sequence.

In some embodiments, the plurality of bit sequences include: 1 1 1 1 1 1 1 1 1 1 1 1 1 1 1 1 1 1 1 1, 0 0 0 0 0 1 0 0 1 1 0 0 1 1 0 0 1 1 0 0, 0 0 0 0 0 0 0 1 1 0 0 1 1 0 0 1 1 0 0 1, 0 0 0 0 0 1 1 1 0 0 0 0 1 1 1 1 0 0 0 0, 0 0 0 0 0 0 1 0 0 1 0 1 1 0 1 0 0 1 0 1, 0 0 0 0 0 1 0 0 0 0 1 1 1 1 0 0 0 0 1 1, 0 0 0 0 0 0 0 1 0 1 1 0 1 0 0 1 0 1 1 0, 0 0 0 0 0 1 1 1 1 1 1 1 0 0 0 0 0 0 0 0, 0 0 0 0 0 0 1 0 1 0 1 0 0 1 0 1 0 1 0 1, 0 0 0 0 0 1 0 0 1 1 0 0 0 0 1 1 0 0 1 1, 1 1 1 1 1 0 0 0 0 0 0 0 0 0 0 0 0 0 0 0, 0 0 0 0 0 0 0 1 1 0 0 1 0 1 1 0 0 1 1 0, 0 0 0 0 0 1 1 1 0 0 0 0 0 0 0 0 1 1 1 1, 0 0 0 0 0 0 1 0 0 1 0 1 0 1 0 1 1 0 1 0, 0 0 0 0 0 1 0 0 0 0 1 1 0 0 1 1 1 1 0 0, or 0 0 0 0 0 0 0 1 0 1 1 0 0 1 1 0 1 0 0 1.

In some embodiments, the plurality of bit sequences are modified by changing an order of the rows of the plurality of bit sequences or changing an order of the columns of the plurality of bit sequences.

In some embodiments, the plurality of bit sequences include: 0 0 0 0 0 0 0 0 0 0 0 0 0 0 0 0 0 0 0 0, 1 1 1 1 1 0 1 1 0 0 1 1 0 0 1 1 0 0 1 1, 1 1 1 1 1 1 1 0 0 1 1 0 0 1 1 0 0 1 1 0, 1 1 1 1 1 0 0 0 1 1 1 1 0 0 0 0 1 1 1 1, 1 1 1 1 1 1 0 1 1 0 1 0 0 1 0 1 1 0 1 0, 1 1 1 1 1 0 1 1 1 1 0 0 0 0 1 1 1 1 0 0, 1 1 1 1 1 1 1 0 1 0 0 1 0 1 1 0 1 0 0 1, 1 1 1 1 1 0 0 0 0 0 0 0 1 1 1 1 1 1 1 1, 1 1 1 1 1 1 0 1 0 1 0 1 1 0 1 0 1 0 1 0, 1 1 1 1 1 0 1 1 0 0 1 1 1 1 0 0 1 1 0 0, 0 0 0 0 0 1 1 1 1 1 1 1 1 1 1 1 1 1 1 1, 1 1 1 1 1 1 1 0 0 1 1 0 1 0 0 1 1 0 0 1, 1 1 1 1 1 0 0 0 1 1 1 1 1 1 1 1 0 0 0 0, 1 1 1 1 1 1 0 1 1 0 1 0 1 0 1 0 0 1 0 1, 1 1 1 1 1 0 1 1 1 1 0 0 1 1 0 0 0 0 1 1, or 1 1 1 1 1 1 1 0 1 0 0 1 1 0 0 1 0 1 1 0.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description, serve to explain the principles of the disclosure.

FIG. 1 illustrates a block diagram of an exemplary communication system, according to some embodiments of the present disclosure.

FIG. 2A illustrates an exemplary data packet structure according to some embodiments of the present disclosure.

FIG. 2B illustrates a block diagram of a PHR having a first part and a second part, according to some embodiments of the present disclosure.

FIG. 2C is a table showing a plurality of data modes each corresponding to a respective index of a first part of the PHR, according to some embodiments of the present disclosure.

FIG. 3A illustrates an example set of bit sequences for encoding the first part of PHR for mapping different data modes, according to some embodiments of the present disclosure.

FIG. 3B illustrates Hamming distances amongst the bit sequences in FIG. 3A, according to some embodiments of the present disclosure.

FIGS. 4A, 4C, 4E, 4G, 4I, 4K, 4M, 4O, 4Q, 4S, 4O, and 4U each illustrates an exemplary set of bit sequences for encoding the first part of PHR, according to some embodiments of the present disclosure.

FIGS. 4B, 4D, 4F, 4H, 4J, 4L, 4N, 4P, 4R, and 4T respectively illustrates Hamming distances amongst the bit sequences in FIGS. 4A, 4C, 4E, 4G, 4I, 4K, 4M, 4O, 4Q, and 4S, according to some embodiments of the present disclosure.

FIGS. 5A-5C each illustrates a method for implementing the PHR processing in UWB communication, according to some aspects of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein. Additionally, like reference numerals denote like features throughout specification and drawings.

It should be appreciated that the blocks in each signaling diagram or flowchart and combinations of the signaling diagrams or flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each signaling diagram or flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction for performing the functions described in connection with a block(s) in each signaling diagram or flowchart. Since the computer program instructions may be equipped in a computer or other programmable data processing devices, instructions that generate a process executed by a computer as a series of operational steps are performed by the computer or other programmable data processing devices and operate the computer or other programmable data processing devices may provide steps for executing the functions described in connection with a block(s) in each signaling diagram or flowchart.

Each block may represent a module, segment, or part of a code including one or more executable instructions for executing a specified logical function(s). Further, it should also be noted that in some replacement execution examples, the functions mentioned in the blocks may occur in different orders. For example, two blocks that are consecutively shown may be performed substantially simultaneously or in a reverse order depending on corresponding functions.

Hereinafter, embodiments are described in detail with reference to the accompanying drawings. Further, although a communication system using ultra-wideband (UWB) is described in connection with embodiments, as an example, the embodiments may also apply to other communication systems with similar technical background or features. For example, a communication system using Bluetooth or ZigBee may be included therein. Further, embodiments may be modified in such a range as not to significantly depart from the scope of the present disclosure under the determination by one of ordinary skill in the art and such modifications may be applicable to other communication systems.

IEEE 4ab is introducing a two-part PHY Header (PHR) for a data packet. The first part (e.g., PHR1) is often shorter than the second part (e.g., PHR2), and includes only a few information bits, such as 2, 3, 4 or 5 bits. PHR1 indicates a modulation rate of PHR2 and the subsequent data payload and possibly other modulation parameters such as coding scheme of PHR2 and/or the coding scheme of the subsequent data payload. PHR1 is often encoded for increased robustness. The number of bits representing PHR1, after the encoding, is therefore often higher that the number of the information bits. To avoid the situation where PHR1 limits the performance of the packet, the performance of the PHR1 should be at least as good as that of PHR2 or that of the strongest supported data mode.

PHR1 and PHR2 are encoded and transmitted for the transmission of various data modes. The strongest data mode, operated at low signal-to-noise ratio (SNR) conditions, can be transmitted at the slowest 1.9 Mbps modulation rate and coded with low-density parity-check code (LDPC) scheme using full-parity option. The full-parity option is based on encoding and transmitting more parity bits than the information bits resulting in coding-rate being effectively lower than ½. The transmitter can strengthen the data packet by adopting the full-parity option, but can cause issues for the reception of the other parts of the data packet (like preamble, start frame delimiter (SFD), PHR1, PHR2), as the receiver may struggle to match the increased sensitivity of the data packet. Failure to match the sensitivity of the data packet can result in new bottlenecks in the system and the overall performance loss.

To prevent these issues, the algorithm processing and the lengths of the preamble/SYNC is adjusted for the receiver to have sufficient performance. PHR2, which is often coded using standard convolutional code, can be transmitted at a reduced modulation rate, e.g., ½, ⅓ or ¼, of the rate of the data payload to match the LDPC performance. That leaves PHR1 to be optimized.

One way to strengthen the PHR1 performance is to reduce its modulation rate. For example, reducing the modulation rate of PHR1 by 50% improves the sensitivity by 3 dBs. However, since PHR1 is often transmitted at a fixed modulation rate (unlike PHR2 which may be transmitted at a modulation rate related to the modulation rate of the data payload), the reduction of PHR1's modulation rate can increase the overhead, e.g., causing longer duration to transmit PHR1. The time to transmit PHR1 may become a significant part of the frame duration at higher data rates. Thus, a coding scheme to facilitate robust transmission of a data mode without causing undesirable long duration by PHR1 is needed. Detailed description of two-part PHR, encoding, and transmission was described in U.S. Provisional Application 63/458,979, titled “Systems And Methods For Providing Dynamic Data Rates Through Dynamic Header Encoding,” which is incorporated herein by reference in its entirety.

Embodiments of the present disclosure provide a method for encoding PHR1 that allows a desired data mode, e.g., the slowest/strongest data mode, to be transmitted with improved robustness without compromising the transmission time. The present disclosure provides sets of bit sequences used for encoding information bits of PHR1. Each set of bit sequences include up to 2^{N} bit sequences, N being the number of information bits of PHR1. Each bit sequence includes a plurality of, e.g., 20, binary bits, i.e., 0s and/or 1s. Bit sequences may be different from another bit sequences by a non-uniform Hamming distance (also referred to as a variable Hamming distance). The Hamming distance between two bit sequences of equal length is the number of positions at which the corresponding bits are different. For example, the hamming distance between the bit sequences “10101” and “11110” is 3. A minimum Hamming distance is an approximate measure of the code's decoding performance. The higher the minimum Hamming distance, the more a bit-sequence is different from other bit-sequences and, therefore, its decoding performance will be higher, making it more suitable for use in low-SNR conditions. The non-uniform Hamming distance of a bit sequence may correspond to a coding strength of the mapped bit sequence from the plurality of other bit sequences.

Considering a bit sequence and its Hamming distances to all other bit sequences in the set, the term “the minimum Hamming distance” is introduced as being an estimate of the effective decoding performance of one selected bit sequence versus all the remaining bit sequences. In the presented example, 4I/4J, there is a first bit sequence of which the minimum Hamming distance to all other bit sequences is at least 13. The minimum Hamming distance of the first bit sequence may be significantly greater than the minimum Hamming distance of a second bit sequence (or other bit sequences), making the first bit sequence more distinguishable than the second bit sequence (or other bit sequences) in decoding. The information bits of PHR1 may be encoded with one of the bit sequences using variable Hamming distance mapping (VDM). In some embodiments, the slowest/strongest data mode (e.g., LDPC-coded 1.9 Mbps) may be mapped to the bit sequence (e.g., the first bit sequence) that has the highest minimum Hamming distance from other bit sequences, which are mapped to faster data modes. This will make decoding of the PHR1 indicating the slowest/strongest data mode more robust. The disclosed method and system may be used in any suitable communication system that transmits a set of modulated data, such as ultra-wideband (UWB), WiFi, Bluetooth low energy (BLE), etc.

In some embodiments, the information bits have 4 bits, and a set of bit sequences includes up to 16 different bit sequences. The information bits may be mapped to one of the bit sequences in the set, depending on the data mode carried by the information bits. In various embodiments, the set of bit sequences may be generated by using K=7 convolutional code which adds 6 tail-bits (4+6=10 information bits total), which after encoding, would result in 20 encoded output bits. However, the performance of such PHR1 sequences, even if transmitted at ½ of the payload modulation rate, may be worse than the strongest data-modes (encoded using advanced coding method like LDPC), thus, becoming the performance bottleneck. To avoid this, the PHR1 may be transmitted even slower, at ⅓ or even ¼ of the data payload rate. This however, may increase the PHR1 duration and the overall overhead. Other suitable ways to generate the bit sequences are also in the scope of the present disclosure. The disclosed bit sequences and VDM may reduce the duration to transmit PHR1 and thus, the overhead, without suffering performance degradation.

In some embodiments, the non-uniform Hamming distance corresponds to the minimum squared Euclidean distance between mapped bit sequence and the plurality of bit sequences. For example, if the modulation scheme uses a quadrature phase shift keying (QPSK) constellation then adjacent symbols in the 4 point QPSK constellation have a squared Euclidian distance of d2 whereas opposite symbols in the 4 point QPSK constellation have a squared Euclidean distance of 2d2. Sequence of bits are mapped onto sequences of symbols and the squared Euclidean distance between sequences will be the sum of the squared Euclidean distances between the constituent symbols.

In some embodiments, the non-uniform Hamming distance corresponds to the minimum squared Euclidean distance between allowed mapped bit sequences and the plurality of allowed bit sequences. For example, if the modulation scheme uses an FEC scheme like a convolutional code then not all transmit sequences are possible to transmit and only the minimum distances between possible transmit sequences should be considered.

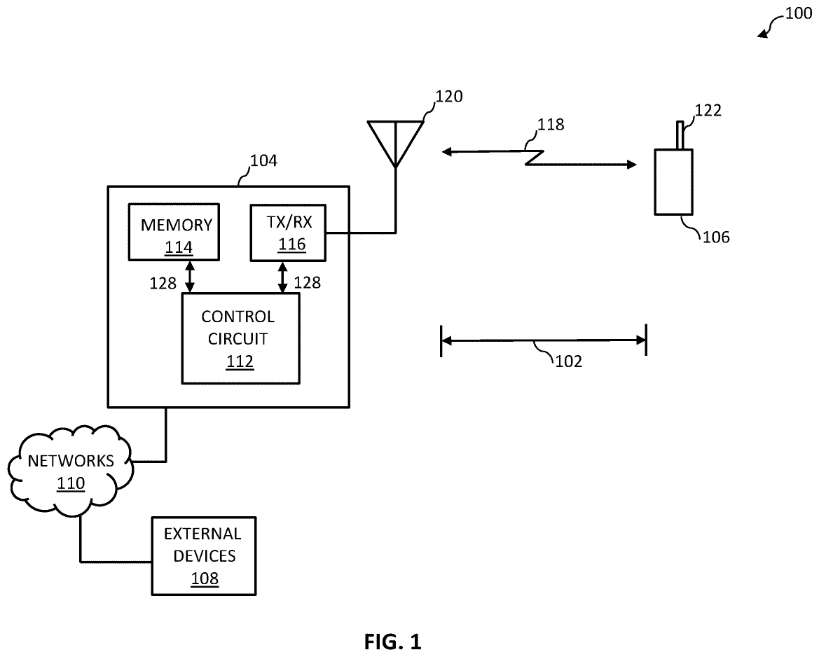

FIG. 1 illustrates an exemplary communication system 100 that includes a first device 104 and a second device 106, according to some embodiments. In some embodiments, communication system 100 may be employed as a location-finding system that determines a distance 102 between first device 104 and second device 106. In some embodiments, first device 104 may be a source, while second device 106 may include a mobile device. First device 104 and second device 106 may communicate with each other through wireless communication. First device 104, provided at a fixed or known location, may be part of another device and/or coupled to external devices 108 through networks 110 such as Internet, the Public Switched Telephone Network (PSTN), or the like. External devices 108 may include any suitable devices that can be communicatively coupled to first device 104 through networks 110, such as an application server. In some embodiments, location-based services may be provided by the external devices 108 when the location of second device 106 is determined. In some embodiments, first device 104 is part of another device that may provide location-based services based on the measurement result of distance 102.

First device 104 may include a control circuit 112, a memory 114, and a transceiver 116. Control circuit 112 may be communicatively coupled to memory 114 and transceiver 116. First device 104 may send and receive signals 118 through an antenna 120 using transceiver 116. For example, antenna 120 may transmit modulated data, such as data packets, to second device 106. A data packet may include PHR1, PHR2, and data payload (or PHY payload). In some embodiments, PHR1 may have the form of pulses or pulse combinations corresponding to a bit sequence 128 that indicates the data mode. Control circuit 112 may include any suitable software and/or hardware for controlling the functions of first device 104. For example, control circuit 112 may include a processor, such as a Central Processing Unit (CPU). Control circuit 112 may generate one or more sets of bit sequences under programming instructions, and may map information bits to a bit sequence 128 based on the modulation rate and coding scheme of PHR2 and/or data payload of a data packet. For example, control circuit 112 may encode the information bits indicating the slowest/strongest data mode for PHR2 and/or data payload to the bit sequence with the largest minimum Hamming distance. Memory 114 may include a random-access memory (RAM), a read-only memory (ROM), an electrically erasable programmable ROM (EEPROM), an optical disk storage, a magnetic disk storage, and/or the like. Operating software, data, and/or signal symbols may be stored in memory 114 for use. For example, one or more sets of bit sequences 128, one or more sets of information bits indicating different data modes (e.g., modulation rates and coding schemes of PHR2 and/or data payload), and certain parameters used for transmitting a data packet may be pre-stored in memory 114. First device 104 may include an antenna 120, communicatively coupled to transceiver 116, for receiving and sending signals such as bit sequences or pulses combinations corresponding to bit sequence 128. Control circuit 112 may transmit the bit sequence 128, which corresponds to the modulation rate and coding scheme of PHR2 and/or data payload carried by the information bits, to transceiver 116, and further antenna 120 to transmit the bit sequence 128 to second device 106.

Second device 106 may include a computing device such as a portable computing device, e.g., a smartphone, a laptop, a tablet, a wearable device, or the like. As shown in FIG. 1, second device 106 may include a receiver and an antenna 122 communicatively coupled together for receiving and sending signals such as a bit sequence or pulse combination corresponding to a bit sequence. Second device 106 may also include a control circuit and a memory, similar to their counterparts in first device 104. Second device 106 may receive signals 118 through antenna 122, and may process signals 118 in the control circuit. In some embodiments, second device 106 may receive a pulse combination (e.g., a sample sequence) as PHR1. The pulse combination may correspond to a bit sequence which indicates a data mode, e.g., modulation rate and coding scheme of PHR2 and/or data payload. The control circuit of second device 106 may decode the pulse combination to locate a matching bit sequence, and determine the data mode, e.g., modulation rate and coding scheme of PHR2 and/or data payload, corresponding to the matching bit sequence. Details of the decoding of the sample sequence is described as follows.

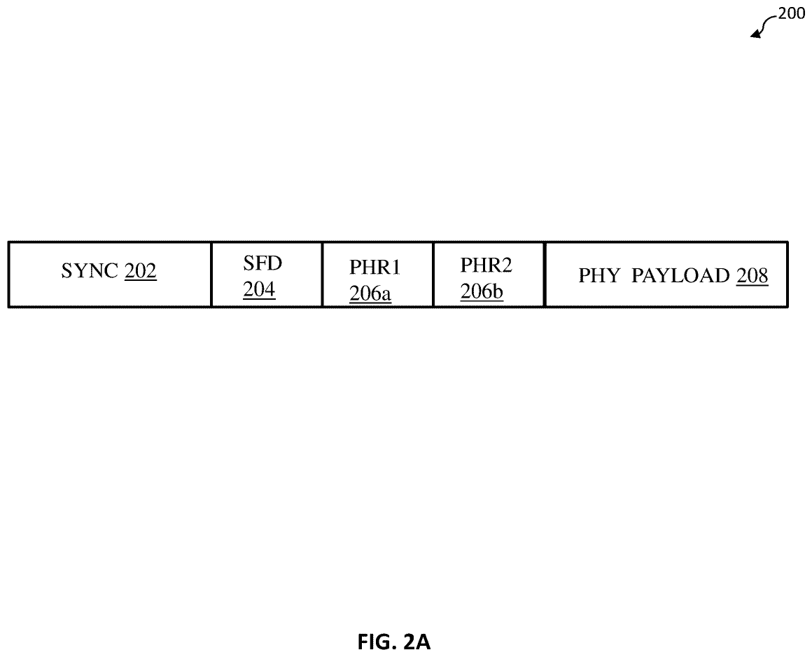

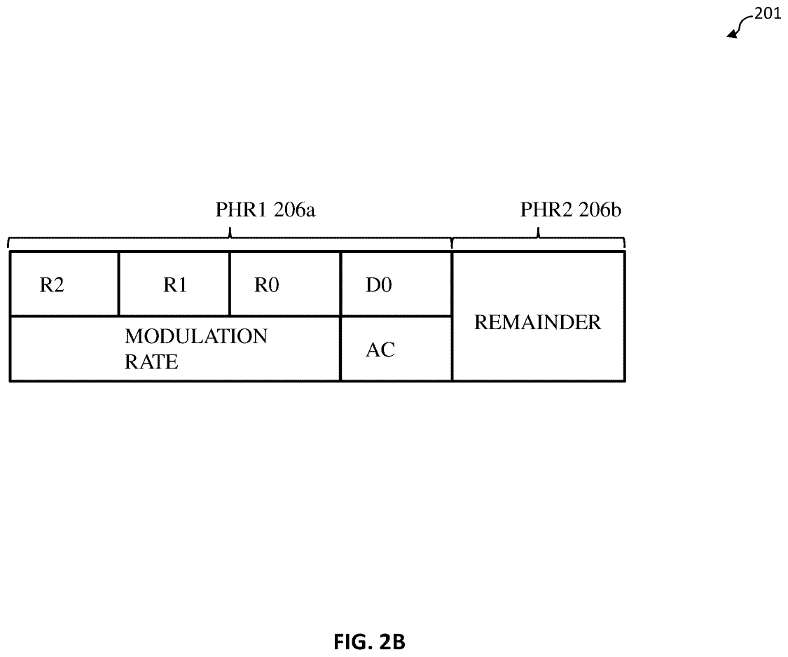

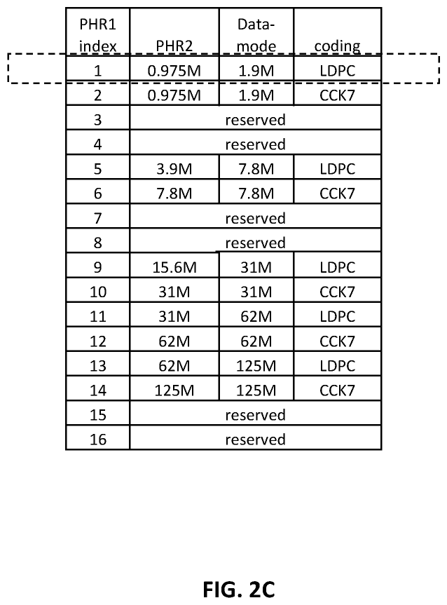

FIG. 2A illustrates a block diagram of a data packet structure 200 used in the transmitting and receiving data between first device 104 and second device 106 in communication system 100, according to some embodiments. Data packet structure 200 may include a synchronization (SYNC) field 202, a start of frame delimiter (SFD) field 204, a first part of physical layer header (PHR1) 206a, a second part of physical layer header (PHR2) 206b, and a physical layer (PHY) payload 208. PHR1 206a and PHR2 206b may form the PHY header of data packet structure 200. FIG. 2B illustrates a PHY header 201, according to some embodiments.

As shown in FIG. 2B, PHY header 201 may include PHR1 206a and PHR2 206b. PHR1 206a may include a plurality of information bits that indicate modulation rate and coding scheme of PHR2 206b and/or PHY payload 208. In some embodiments, PHR1 206a has four information bits R2, R1, R0, and D0. R2, R1, R0, and/or D0 may indicate a modulate rate of PHR2 306b and/or PHY payload 208. DO may be an advanced coding (AC) bit that indicates the coding scheme of PHY payload 208. For example, AC may indicate low-density parity-check (LDPC) used for PHY payload 208. PHR2 206b may include remainder information such as payload length, ranging and/or sensing information, cyclic redundancy check (CRC) bits, etc. In various embodiments, PHR1 206a may indicate the modulation rate and coding scheme of both PHR2 206b and PHY payload 208. In some embodiments, PHR1 206a may indicate the modulation rate and coding scheme of PHR2 206b, which may indicate the modulation rate and coding scheme of PHY payload 208.

FIG. 2C illustrates example PHR1 index to data mode mapping. As shown in FIG. 2C, each data mode corresponds to a respective PHR1 index, which corresponds to a respective combination of information bits. For example, four information bits may be used to correspond to (e.g., be mapped to) 16 data modes. In some embodiments, PHR1−index=1 may correspond data mode at 1.9M with LDPC. In some embodiments, data mode at 1.9M with LDPC may be the slowest/strongest mode that requires sufficiently strong performance of PHR1 206a, which requires performance level of −1.1 dB (the same as PHR2 at 0.975 Mbps). If PHR2 206b is to be transmitted at a lower modulation rate, the PHR1 requirement to match it would be lower than −1.1 dB. As a result, all the other data modes may have worse performance than that due to their faster rates or weaker encoding.

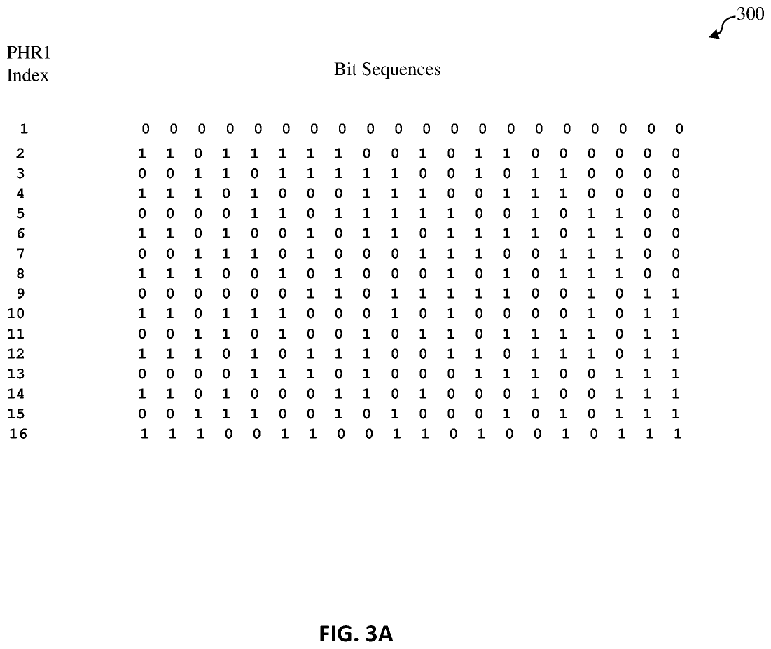

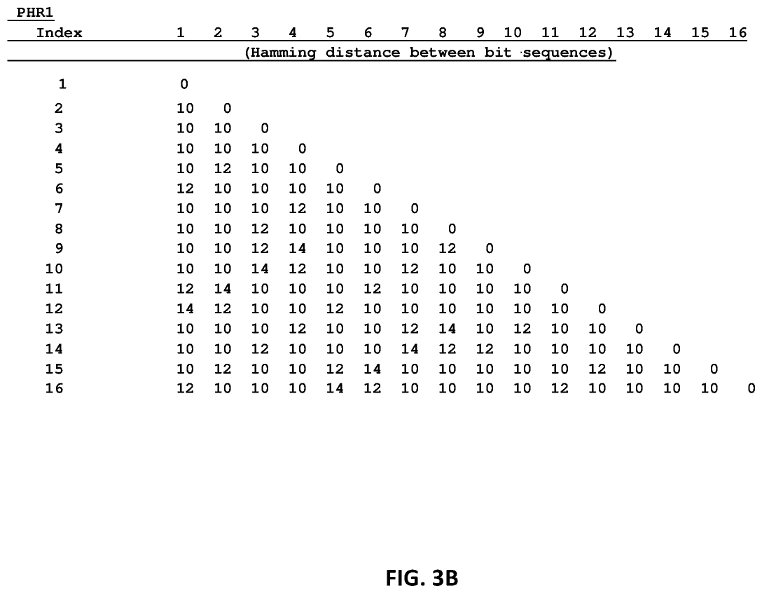

FIG. 3A illustrates an example set 300 of bit sequences used to encoding the information bits of PHR1. FIG. 3B illustrates the Hamming distance between different bit sequences (or different PHR1 indices) in set 300. Each column in FIG. 3B shows the Hamming distance between the bit sequence corresponding to the PHR1 index=column number and all other bit sequences. For example, column 1 of FIG. 3B shows the Hamming distance between the bit sequence corresponding to PHR1 index=1 and each of the bit sequences corresponding to PHR1 index=2, 3, . . . , 16.

As shown in FIGS. 3A and 3B, the Hamming distance between two bit sequences corresponding to different PHR1 indices is relatively uniform. For example, as shown in column 1 of FIG. 3B, the Hamming distance between the bit sequence corresponding to PHR1 index=1 and a bit sequence corresponding to another PHR1 index ranges between 10 and 14, while being mostly 10. As shown in column 2, the Hamming distance between the bit sequence corresponding to PHR1 index=2 and a bit sequence corresponding to another PHR1 index also ranges between 10 and 14, while being mostly 10, and so on and so forth. The relatively uniform Hamming distance may result in that all data modes may have similar decoding performance. However, the similar decoding performance may cause problems for the decoding of bit sequence corresponding to PHR1 index=1 (e.g., the LDPC-coded 1.9 Mbps data mode or the slowest/strongest data mode), which is operated in a condition with a low signal-to-noise ratio (SNR) and thus requires a higher sensitivity requirement from PHR1. On the other hand, bit sequences corresponding to other PHR1 indices, e.g., the CCK7-coded 1.9M data-mode and faster data-modes, may be operated under conditions with higher SNR, thus sensitivity requirement from PHR1 is much lower.

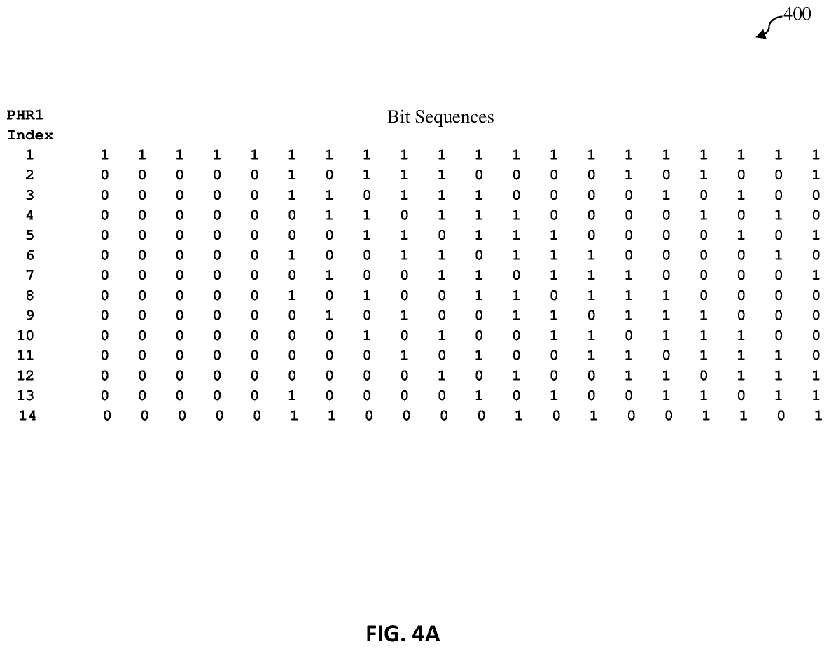

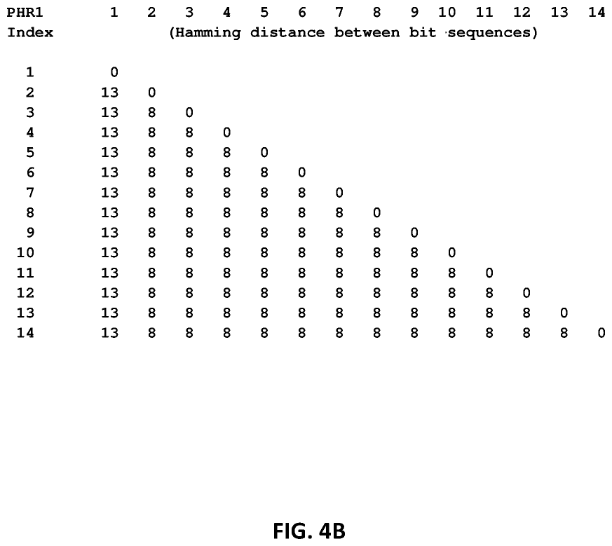

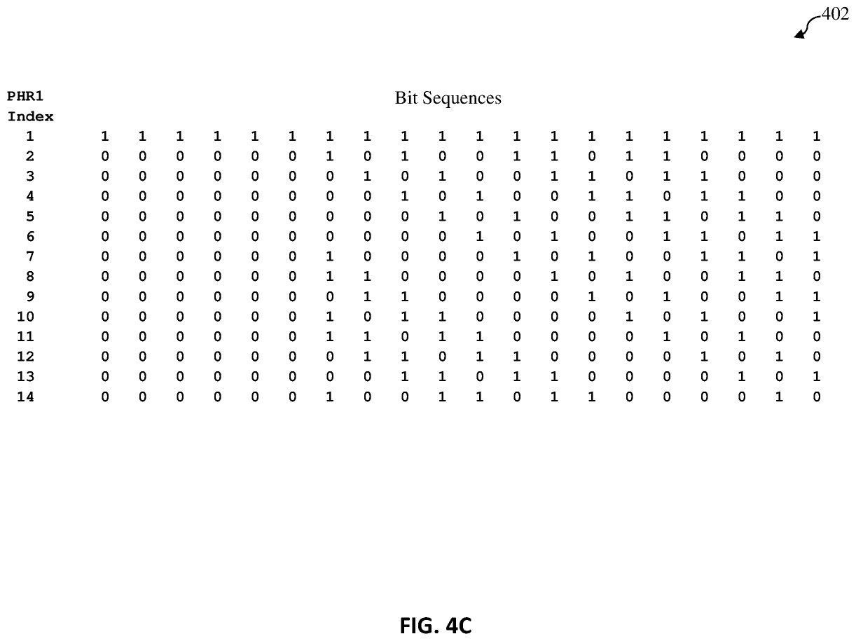

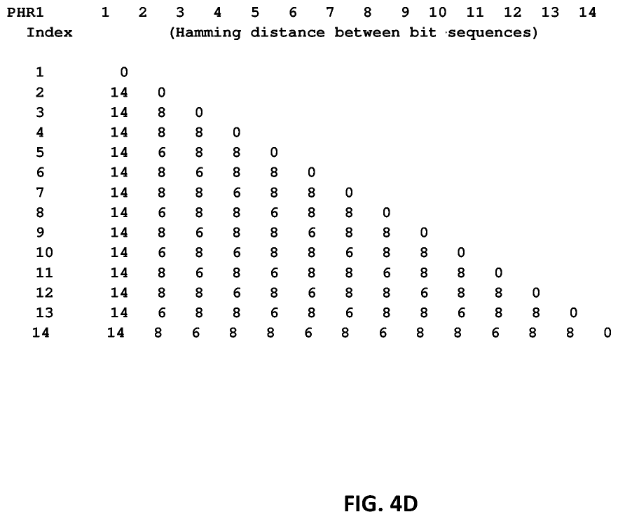

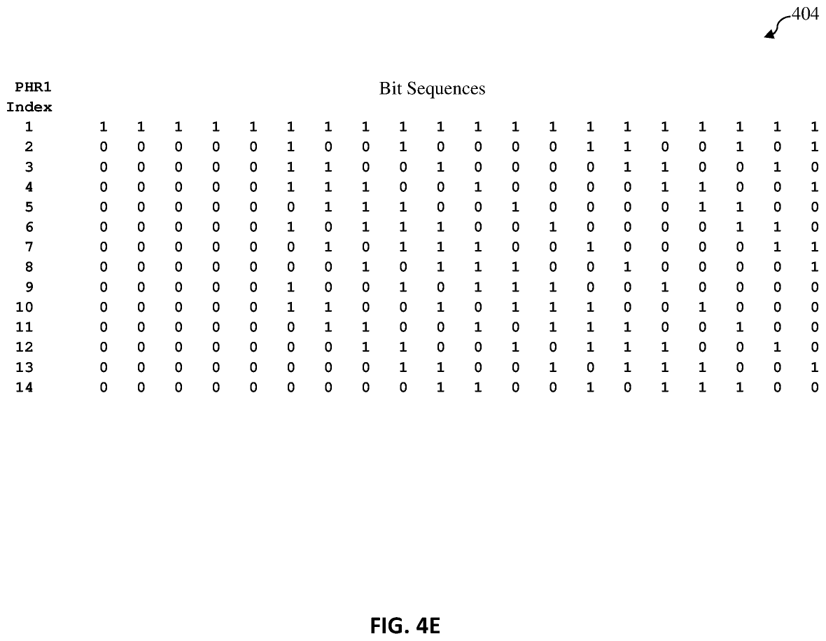

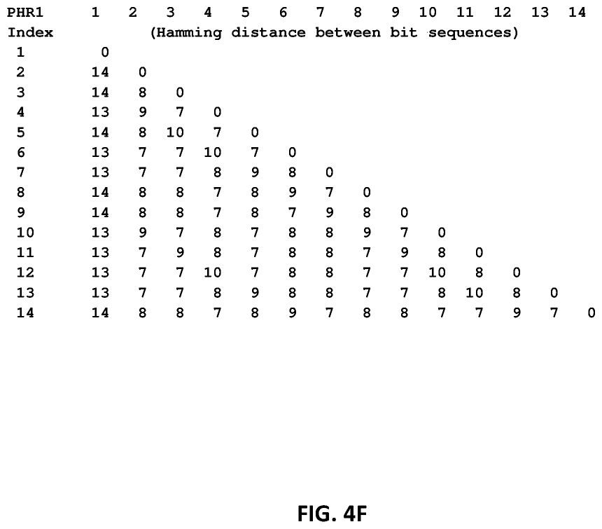

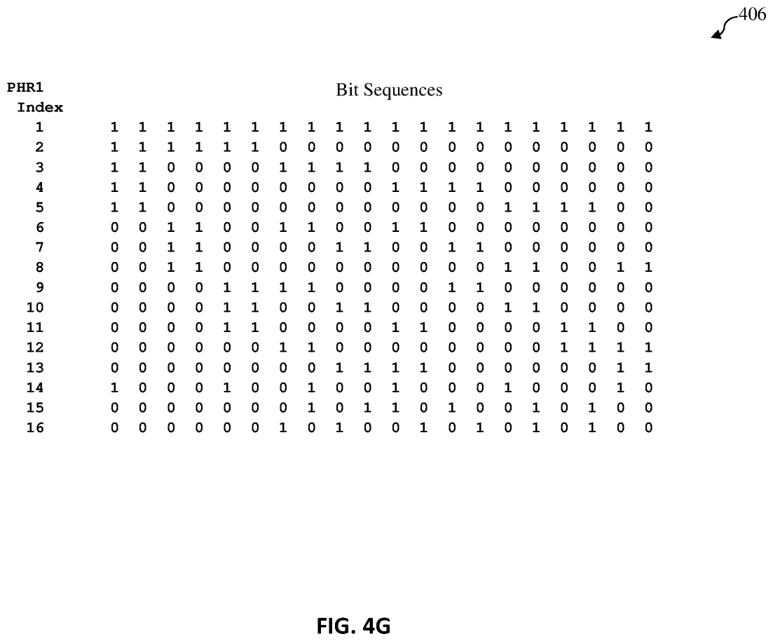

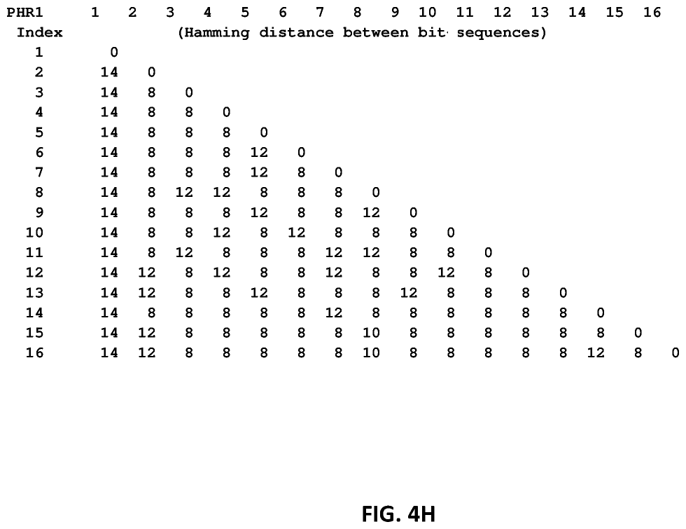

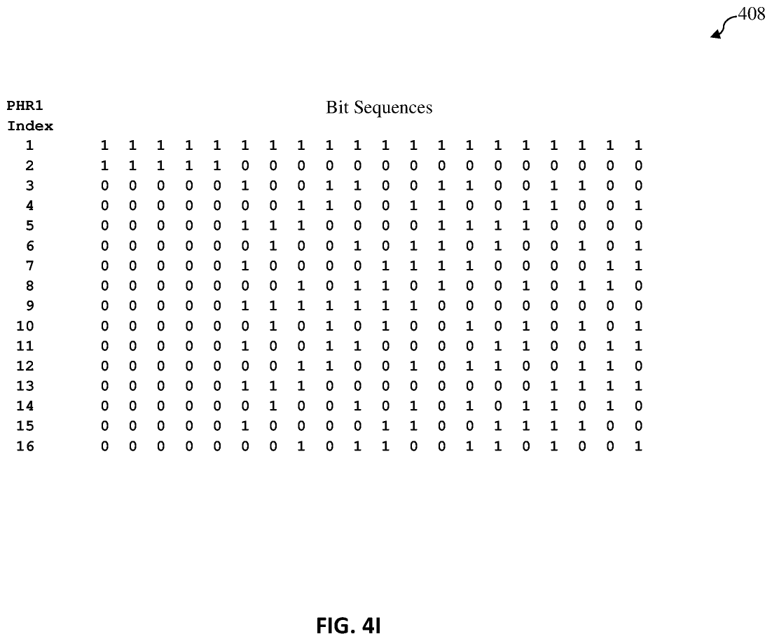

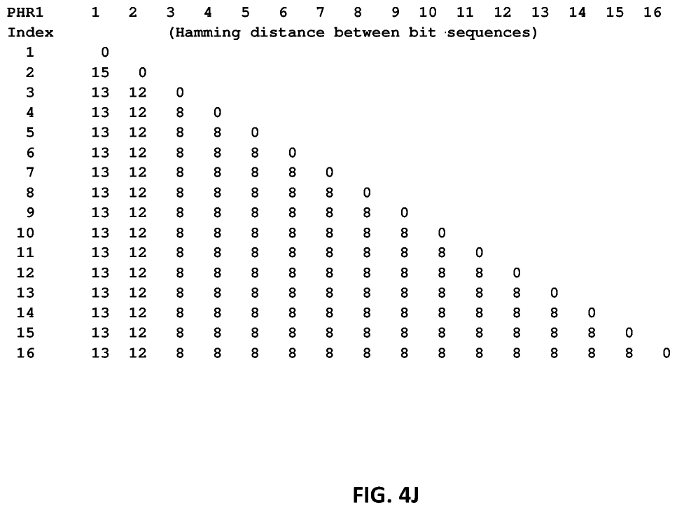

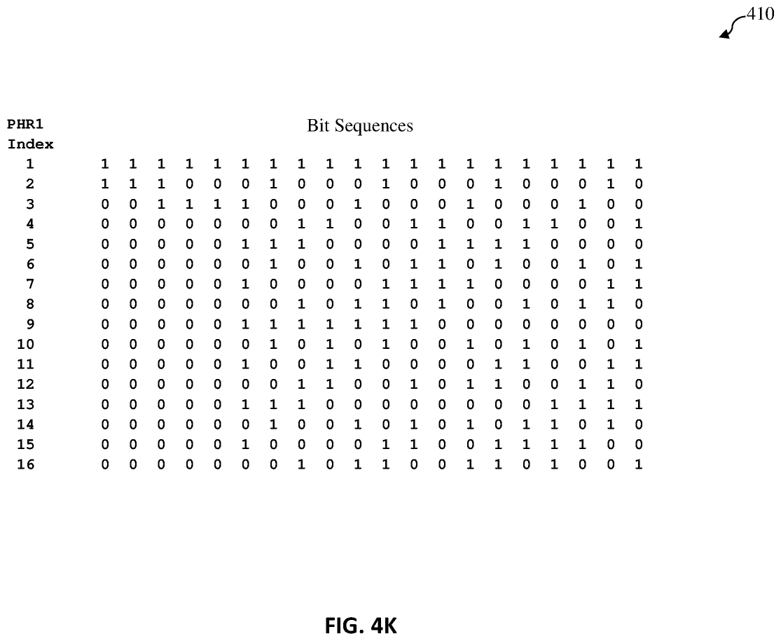

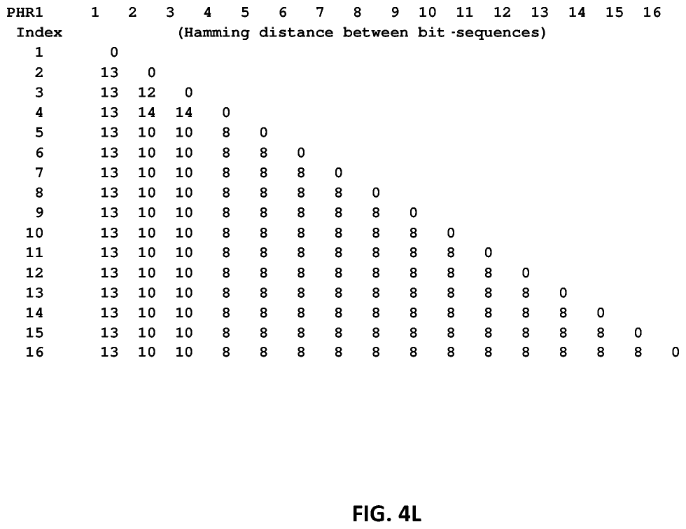

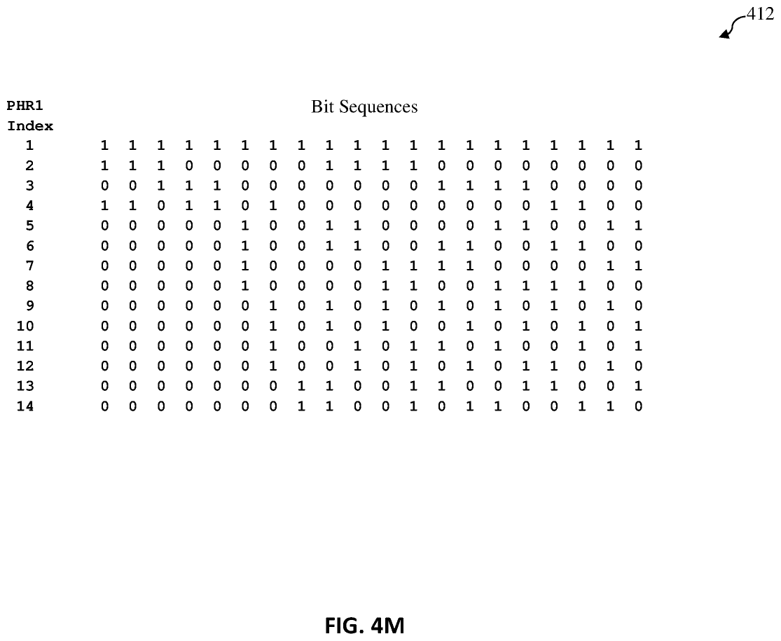

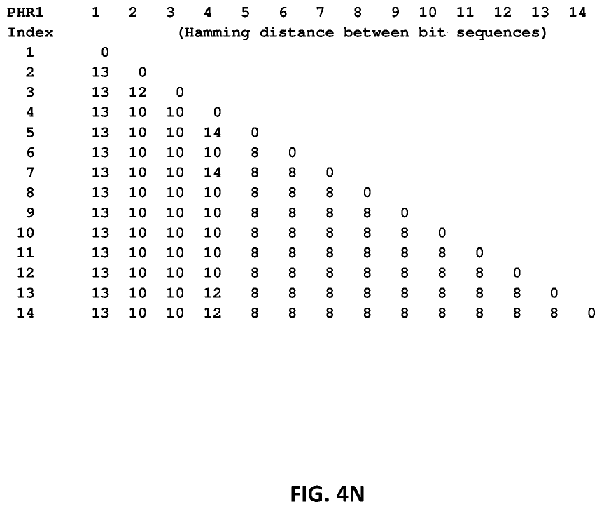

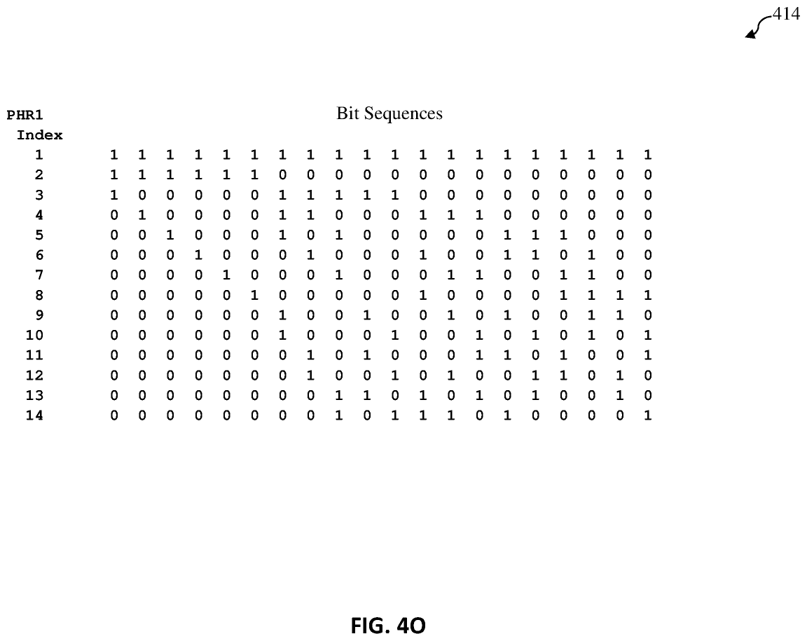

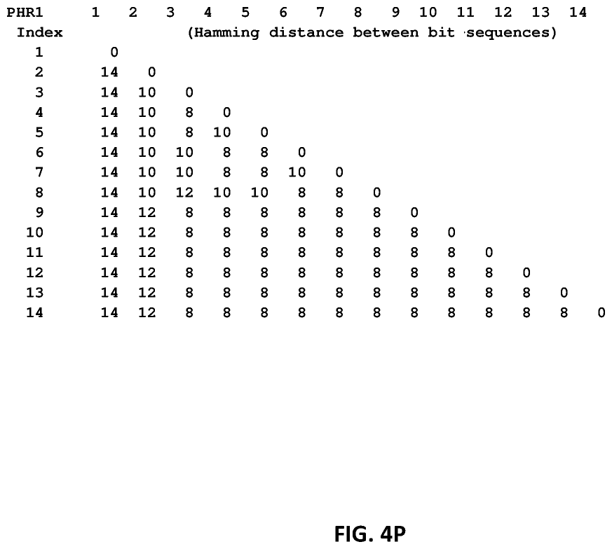

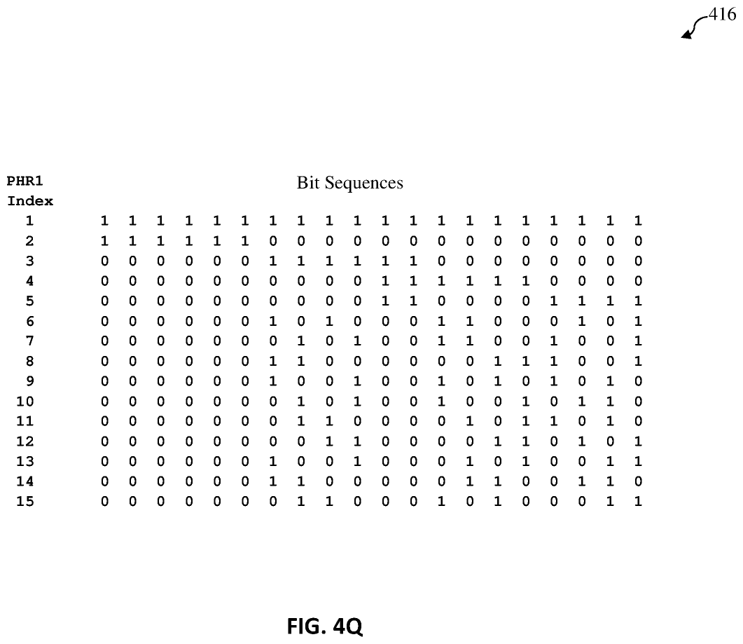

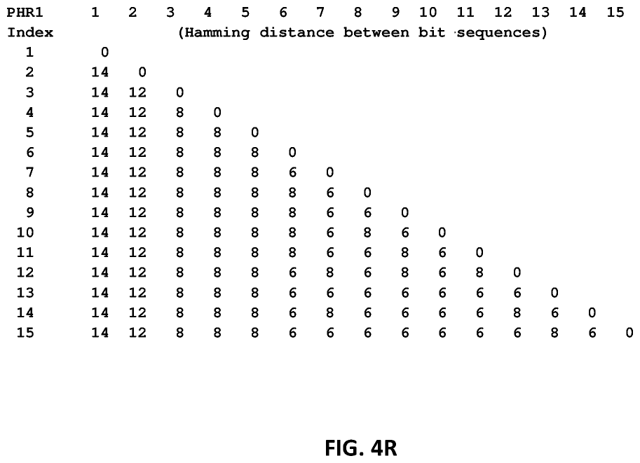

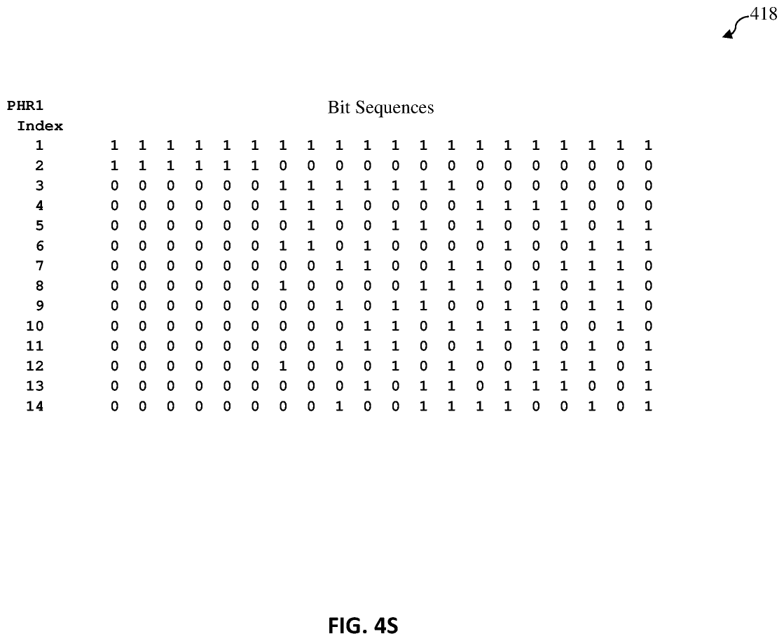

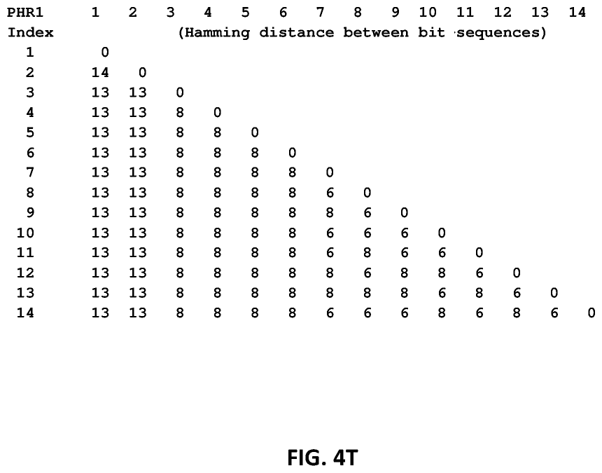

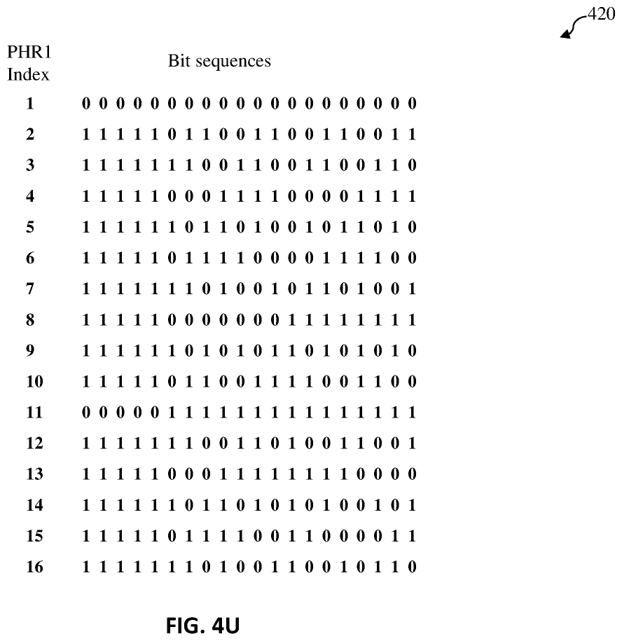

To improve the sensitivity of PHR1 in a condition with relatively low SNR, embodiments of the present disclosure provide alternative coding schemes for PHR1. In some embodiments, the minimum Hamming distance between the bit sequence corresponding to the slowest/strongest data mode and all the other bit sequences is significantly higher than the minimum Hamming distance between one other selected bit sequence to the other bit sequences. This is illustrated for example in FIGS. 4I/4J, where bit sequence index 1 has a Hamming distance of at least 13 (minimum=13) to all the other sequences, while bit sequence index 3 has a Hamming distance of at least 8 (minimum=8), making it less robust, but still suitable to faster/weaker data modes. In some embodiments, the slowest/strongest data mode corresponds to PHR1 index=1. Referring to FIG. 2C, the slowest/strongest data mode may be the LDPC-coded 1.9 Mbps data mode, in an example. The disclosed coding scheme and mapping may improve the decoding robustness and decoding speed of the slowest/strongest data mode. Meanwhile, the mapping has little or no impact on the decoding of faster data modes, which are operated under much higher SNR conditions. FIGS. 4A-4O illustrate examples of the sets of bit sequences used to encode the information bits. With the proposed mapping, PHR1 index=1 sequence has a packet error rate (PER)=1% performance level=−1.8 dB, which is better than the requirement (−1.1 dB). The remaining sequences have their PER=1% level around 2.2 dB, which is also better than the data modes they may indicate.

In some embodiments, the decoding of the bit sequences may be done by a suitable method, such as pattern matching i.e., calculating the distance of the received sample sequence to all bit sequences and selecting the bit sequence with the smallest error. Because the number of bit sequences is up to 2^{N}, which is a relatively small number, the implementation of decoding may be simple and fast.

In some embodiments, only one PHR1 index (e.g., the PHR1 index=1) or data mode has been strengthened by mapping to a bit sequence with the minimum Hamming distance different and higher than the Hamming distances of other bit sequences, which are mapped to other PHR1 indices/data modes. In some embodiments, more than one PHR1 indices or data modes may be strengthened by being mapped to respective bit sequences each with a minimum Hamming distance different and higher than the Hamming distances of other bit sequences, which are mapped to other PHR1 indices/data modes. In various embodiments, the more than one PHR1 indices or data modes may be the slowest/strongest data modes, or may be any selected data modes.

In some embodiments, the bit sequence corresponding to PHR1 index=1 (e.g., having the minimum Hamming distance different and higher than the Hamming distances of bit sequences mapped to other PHR1 indices) is mapped to the slowest/strongest data mode, which is 1.9 Mbps data mode with LDPC encoding. The performance requirement is-1.0 dB (at PER=1%). For 1.9 Mbps with CCK7 coding, the requirement is 2.3 dB. In some embodiments, the sets of bit sequences of this disclosure exceed the requirements.

In some embodiments, shorter bit sequences are used in the set of bit sequences with VDM, as disclosed herein. For example, a bit sequence may be less than or equal to 20 bits. Shortening the bit sequences with VDM may reduce PHR1 overhead with sufficiently high PHR1 performance.

FIG. 4A illustrates a set 400 of bit sequences, according to some embodiments. Set 400 may include 14 bit sequences, each has 20 bits of 1s and/or 0s. FIG. 4B illustrates the Hamming distance between each bit sequence and other sequences. As shown in FIG. 4B, the minimum Hamming distance between the bit sequence corresponding to PHR1 index=1 and other bit sequences is 13, and the minimum Hamming distance between any other bit sequence and another bit sequence is 8. In some embodiments, set 400 offers PER=1% performance around −1.5 dB for bit sequence corresponding to PHR1 index=1, and 0.8 dB for the remaining bit sequences.

FIG. 4C illustrates a set 402 of bit sequences, according to some embodiments. Set 402 may include 14 bit sequences, each has 20 bits of 1s and/or 0s. FIG. 4D illustrates the Hamming distance between each bit sequence and other sequences. As shown in FIG. 4D, the minimum Hamming distance between the bit sequence corresponding to PHR1 index=1 and other bit sequences is 14, and the minimum Hamming distance between any other bit sequence and another bit sequence is 6. In some embodiments, set 402 offers PER=1% performance around −1.9 dB for bit sequence corresponding to PHR1 index=1, and 1.3 dB for the remaining bit sequences.

FIG. 4E illustrates a set 404 of bit sequences, according to some embodiments. Set 404 may include 14 bit sequences, each has 20 bits of 1s and/or 0s. FIG. 4D illustrates the Hamming distance between each bit sequence and other sequences. As shown in FIG. 4F, the minimum Hamming distance between the bit sequence corresponding to PHR1 index=1 and other bit sequences is 13, and the minimum Hamming distance between any other bit sequence and another bit sequence is 7. In some embodiments, set 404 offers PER=1% performance around −1.7 dB for bit sequence corresponding to PHR1 index=1, and about 1.0 dB for the remaining bit sequences.

FIG. 4G illustrates a set 406 of bit sequences, according to some embodiments. Set 406 may include 16 bit sequences, each has 20 bits of 1s and/or 0s. FIG. 4H illustrates the Hamming distance between each bit sequence and other sequences. As shown in FIG. 4H, the minimum Hamming distance between the bit sequence corresponding to PHR1 index=1 and other bit sequences is 14, and the minimum Hamming distance between any other bit sequence and another bit sequence is 8. In some embodiments, set 406 offers PER=1% performance around −1.8 dB for bit sequence corresponding to PHR1 index=1, and between about 0.6 dB and about 108 dB for the remaining bit sequences.

FIG. 4I illustrates a set 408 of bit sequences, according to some embodiments. Set 408 may include 16 bit sequences, each has 20 bits of 1s and/or 0s. FIG. 4J illustrates the Hamming distance between each bit sequence and other sequences. As shown in FIG. 4J, the minimum Hamming distance between the bit sequence corresponding to PHR1 index=1 and other bit sequences is 13, the minimum Hamming distance between the bit sequence corresponding to PHR1 index=2 and other bit sequences is 12, and the minimum Hamming distance between any other bit sequence and another bit sequence is 8. In some embodiments, set 408 offers PER=1% performance around-1.4 dB for bit sequence corresponding to PHR1 index=1, PER=1% performance around-1.15 dB for bit sequence corresponding to PHR1 index=2, and about 0.8 dB for the remaining bit sequences.

FIG. 4I illustrates a set 408 of bit sequences, according to some embodiments. Set 408 may include 16 bit sequences, each has 20 bits of 1s and/or 0s. FIG. 4J illustrates the Hamming distance between each bit sequence and other sequences. As shown in FIG. 4J, the minimum Hamming distance between the bit sequence corresponding to PHR1 index=1 and other bit sequences is 13, the minimum Hamming distance between the bit sequence corresponding to PHR1 index=2 and other bit sequences is 12, and the minimum Hamming distance between any other bit sequence and another bit sequence is 8. In some embodiments, set 408 offers PER=1% performance around-1.4 dB for bit sequence corresponding to PHR1 index=1, PER=1% performance around-1.15 dB for bit sequence corresponding to PHR1 index=2, and about 0.8 dB for the remaining bit sequences. In some embodiments, the bit sequence corresponding to PHR1 index=2 may be mapped to another data mode, e.g., another strong/slow data mode.

FIG. 4K illustrates a set 410 of bit sequences, according to some embodiments. Set 410 may include 16 bit sequences, each has 20 bits of 1s and/or 0s. FIG. 4L illustrates the Hamming distance between each bit sequence and other sequences. As shown in FIG. 4L, the minimum Hamming distance between the bit sequence corresponding to PHR1 index=1 and other bit sequences is 13, the minimum Hamming distance between the bit sequence corresponding to PHR1 index=2 and other bit sequences is 10, the minimum Hamming distance between the bit sequence corresponding to PHR1 index=3 and other bit sequences is 10, and the minimum Hamming distance between any other bit sequence and another bit sequence is 8. In some embodiments, set 410 offers PER=1% performance around-1.4 dB for bit sequence corresponding to PHR1 index=1, PER=1% performance around-0.3 dB for bit sequences corresponding to PHR1 indices=2 and 3, and 0.8 dB for the remaining bit sequences. In some embodiments, the bit sequences corresponding to PHR1 indices=2 and/or 3 may each be mapped to other data modes, e.g., another strong/slow data modes.

FIG. 4M illustrates a set 412 of bit sequences, according to some embodiments. Set 412 may include 14 bit sequences, each has 20 bits of 1s and/or 0s. FIG. 4N illustrates the Hamming distance between each bit sequence and other sequences. As shown in FIG. 4N, the minimum Hamming distance between the bit sequence corresponding to PHR1 index=1 and other bit sequences is 13, the minimum Hamming distance between the bit sequence corresponding to PHR1 index=2 and other bit sequences is 10, the minimum Hamming distance between the bit sequence corresponding to PHR1 index=3 and other bit sequences is 10, the minimum Hamming distance between the bit sequence corresponding to PHR1 index=4 and other bit sequences is 10, and the minimum Hamming distance between any other bit sequence and another bit sequence is 8. In some embodiments, set 412 offers PER=1% performance around-1.4 dB for bit sequence corresponding to PHR1 index=1, PER=1% performance around-0.3 dB for bit sequences corresponding to PHR1 indices=2, 3, and 4, and 0.8 dB for the remaining bit sequences. In some embodiments, the bit sequences corresponding to PHR1 indices=2, 3, and/or 4 may each be mapped to other data modes, e.g., another strong/slow data modes.

FIG. 4O illustrates a set 414 of bit sequences, according to some embodiments. Set 414 may include 14 bit sequences, each has 20 bits of 1s and/or 0s. FIG. 4P illustrates the Hamming distance between each bit sequence and other sequences. As shown in FIG. 4P, the minimum Hamming distance between the bit sequence corresponding to PHR1 index=1 and other bit sequences is 14, the minimum Hamming distance between the bit sequence corresponding to PHR1 index=2 and other bit sequences is 10, and the minimum Hamming distance between any other bit sequence and another bit sequence is 8. In some embodiments, set 414 offers PER=1% performance around-1.8 dB for bit sequence corresponding to PHR1 index=1, PER=1% performance around-0.3 dB for bit sequence corresponding to PHR1 index=2, and 0.8 dB for the remaining bit sequences. In some embodiments, the bit sequences corresponding to PHR1 index=2 may be mapped to another data mode, e.g., another strong/slow data mode.

FIG. 4Q illustrates a set 416 of bit sequences, according to some embodiments. Set 416 may include 15 bit sequences, each has 20 bits of 1s and/or 0s. FIG. 4R illustrates the Hamming distance between each bit sequence and other sequences. As shown in FIG. 4R, the minimum Hamming distance between the bit sequence corresponding to PHR1 index=1 and other bit sequences is 14, the minimum Hamming distance between the bit sequence corresponding to PHR1 index=2 and other bit sequences is 12, the minimum Hamming distance between the bit sequence corresponding to PHR1 index=3 and other bit sequences is 8, the minimum Hamming distance between the bit sequence corresponding to PHR1 index=4 and other bit sequences is 8, and the minimum Hamming distance between any other bit sequence and another bit sequence is 6. In some embodiments, set 416 offers PER=1% performance around-1.9 dB for bit sequence corresponding to PHR1 index=1, PER=1% performance around-1.3 dB for bit sequence corresponding to PHR1 index=2, PER=1% performance around 0.4 dB for bit sequences corresponding to PHR1 indices=3 and 4, and 1.8 dB for the remaining bit sequences. In some embodiments, the bit sequence corresponding to PHR1 index=2 may be mapped to another data mode, e.g., another strong/slow data mode.

FIG. 4S illustrates a set 418 of bit sequences, according to some embodiments. Set 418 may include 14 bit sequences, each has 20 bits of 1s and/or 0s. FIG. 4T illustrates the Hamming distance between each bit sequence and other sequences. As shown in FIG. 4T, the minimum Hamming distance between the bit sequence corresponding to PHR1 index=1 and other bit sequences is 13, the minimum Hamming distance between the bit sequence corresponding to PHR1 index=2 and other bit sequences is 13, the minimum Hamming distance between the bit sequences corresponding to PHR1 indices=3, 4, 5, and 6 and other bit sequences is 8, and the minimum Hamming distance between any other bit sequence and another bit sequence is 6. In some embodiments, set 418 offers PER=1% performance around-1.6 dB for bit sequences corresponding to PHR1 indices=1 and 2, PER=1% performance around-0.6 dB for bit sequences corresponding to PHR1 indices=3, 4, 5, and 6, and 1.5 dB for the remaining bit sequences. In some embodiments, the bit sequence corresponding to PHR1 indices=2, 4, and 6 may each be mapped to other data modes, e.g., another strong/slow data modes.

In some embodiments, each bit sequence of the present disclosure has inverted bit polarity. That is, the Hamming distances and the minimum Hamming distances remain the same if all the 0s are inverted to 1s, and all the 1s are inverted to 0s in the set. FIG. 4U illustrates a set 420 of bit sequences that has inverted polarity from set 408. In some embodiments, set 420 may be generated by inverting all 1s in set 408 to 0s, and inverting all 0s in set 408 to 1s. Same as set 408, in set 420, the minimum Hamming distance between the bit sequence corresponding to PHR1 index=1 and other bit sequences is 13, the minimum Hamming distance between the bit sequence corresponding to PHR1 index=2 and other bit sequences is 12, and the minimum Hamming distance between any other bit sequence and another bit sequence is 8. In some embodiments, set 408 offers PER=1% performance around-1.4 dB for bit sequence corresponding to PHR1 index=1, PER=1% performance around-1.15 dB for bit sequence corresponding to PHR1 index=2, and about 0.8 dB for the remaining bit sequences. In some embodiments, the bit sequence corresponding to PHR1 index=2 may be mapped to another data mode, e.g., a strong/slow data mode.

In some embodiments, the rows and/or columns of a set may switch, and the Hamming distances and the minimum Hamming distances between two bit sequences may remain unchanged.

The disclosed bit sequences may be generated using various suitable methods. For example, to design a set of bit sequences, the bit sequence corresponding to PHR1 index=1 may first be determined to include all ones. Then to achieve Hamming distance (HD) of at least 13 or 14, all the remaining bit sequences may have a maximum of 7 ones (for HD=13) or 6 ones (for HD=14). To maximize distance between themselves for example to HD=8, an algorithm may be used to place the ones at such positions (in 20-bit long bit sequence), that any sequence pair has up to two ones at the same positions. That means that four ones of the first bit sequence and four ones of the second bit sequence will be at different positions, resulting in HD=8. In some embodiments, some bit sequences may also have fewer ones than mentioned.

In some embodiments, achieving optimal distribution of ones in a bit sequence can be done manually, for example by gradual movement of ones within the sequence or by brute-force analysis according to certain constraints and criteria.

In some embodiments, a search algorithm to generate bit sequences each having a length of 20 bits could be executed in the following steps: In step 1, it is assumed that the most protected bit sequence may include of all ones (e.g., 20 ones). In step 2, a list of all possible bit sequences may be generated with exactly six ones (and 14 zeroes). In step 3, a random sequence may be selected from the list. In step 4, another bit sequence may be searched in the list with the largest sum of Hamming distances from those already selected, subject to there being a minimum Hamming distance to any of those already selected. In step 5, repeat step 4 until enough bit sequences are selected or until the minimum Hamming distance condition is not met.

In some embodiments, the bit sequences may be generated from a well-known sequence like Hadamard matrix, which guarantees certain distances between bit sequences (or from any other shorter set of bit sequences with desired HD properties) and expand the set, e.g., by adding a number of zeroes to certain sequences and a number of ones to other sequences (thus increasing their relative Hamming distance). The strongest bit sequence can include all ones, to provide it with the maximum Hamming distance.

In some embodiments, a set of bit sequences may be generated from a smaller set of bit sequences and then search for additional bit sequences (e.g., one by one) by executing a random search, testing a number of pseudo-randomly generated bit sequences to see if they satisfy certain criteria (for example the new bit sequence has the required HD from all The generated set of bit sequence may be stored on both transmitter and receiver sides. The transmitter may encode the information bits of PHR1 into a bit sequence for transmission of a pulse combination (e.g., a sample sequence) corresponding to the bit sequence.

The receiver may receive the sample sequence and decode the sample sequence using pattern matching to determine the bit sequence that matches/corresponds to the sample sequence. The receiver may further determine the modulation rate and coding scheme of PHR2 and or data payload to be a modulation rate and coding scheme indicated by the mapped bit sequence. In some embodiments, the decoding of the PHR1 includes: converting, in each of the plurality of bit sequences, the plurality of ones to a plurality of minus numbers (e.g., minus ones) and the plurality of zeros to a plurality of positive numbers (e.g., positive ones). The sample sequence may be multiplied with each of the plurality of converted bit sequences. Each bit of the sample sequence may be multiplied with a bit of a same position in each of the plurality of converted bit sequences to obtain a product for the position. For each of the plurality of converted bit sequences, products for all positions are summed to obtain a sum for the respective converted bit sequence. A highest sum may be selected from sums of all converted bit sequences, and the modulation rate of the PHR2 may be determined to be a modulation rate indicated by the bit sequence corresponding to the highest sum.

For example, if the PHR1 ideal bit should be +1 and received sample bit is positive, the multiplication will give positive number; if the PHR1 ideal bit should be (−1) and received sample is negative, multiplication will give positive number. That is, the match between the PHR1 ideal bit and sample bit may render a positive number. However, if PHR1 bit sequence is compared against the sample sequence, multiplications will be negative and will lower the metric. This is why HD needs to be as high as possible, so that the PHR1 bit sequences were sufficiently different to be able to distinguish between them. If HD was low, they would be similar thus making it hard to distinguish between them in noisy conditions.

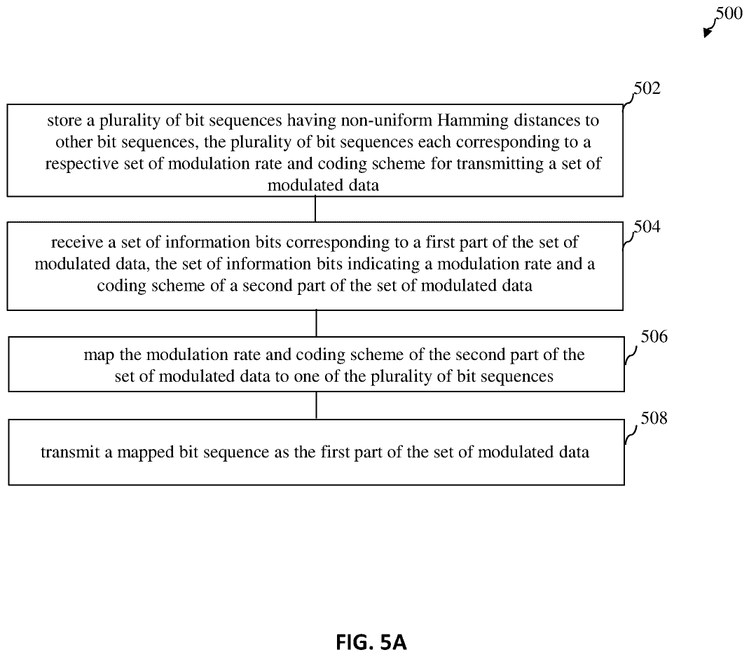

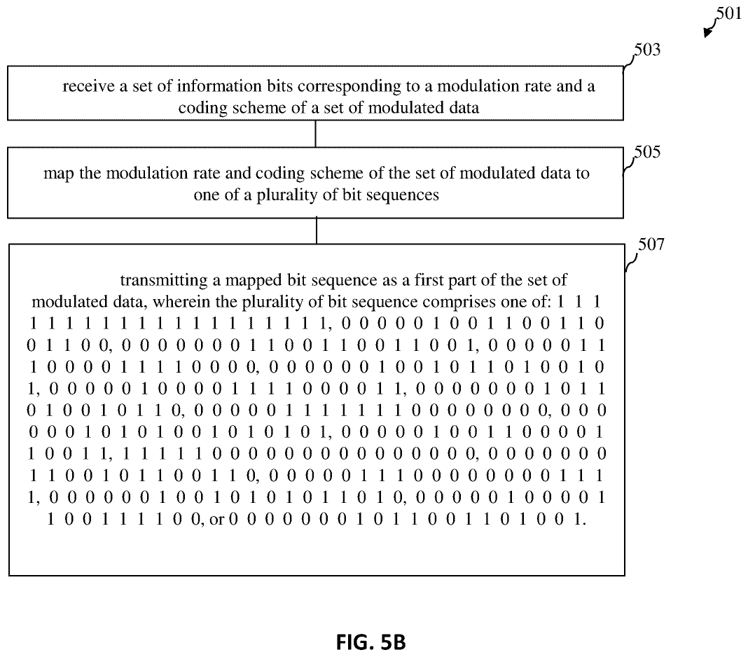

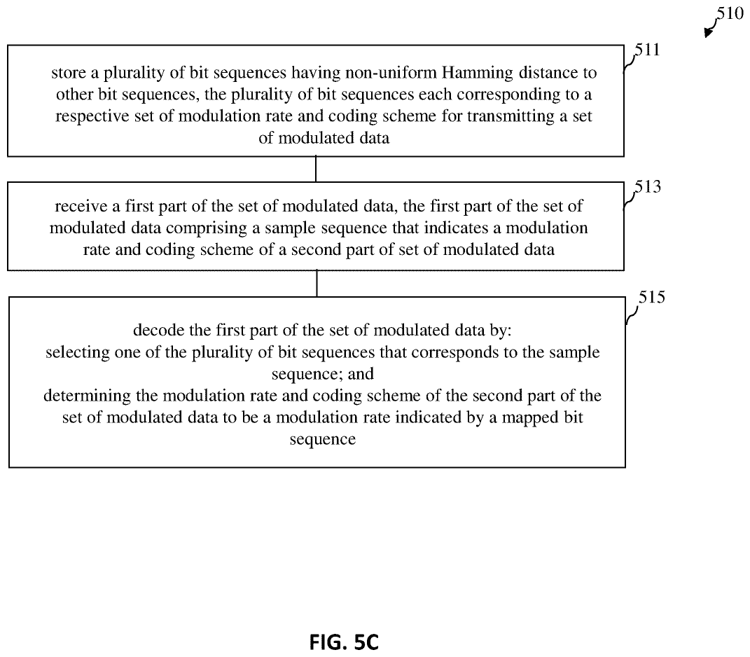

FIG. 5A is a flowchart of a method 500 for a transmitter (e.g., a UWB device) to implement the encoding and transmission of PHR1 in a communication system, according to some embodiments of the present disclosure. Method 500 is merely an example, and is not intended to limit the present disclosure beyond what is explicitly recited in the claims. Additional operations can be provided before, during, and after the method 500, and some operations described can be replaced, eliminated, or moved around for additional embodiments of method 500. For ease of illustration, FIG. 5A is described in connection with FIGS. 1, 2A-2C, and 4A-4U.

At step 502, a plurality of bit sequences of non-uniform Hamming distance from one another is stored. The plurality of bit sequences each corresponds to a respective set of modulation rate and coding scheme for transmitting a set of modulated data. Referring back to FIG. 1, the transmitter (e.g., first device 104) may store a set of bit sequences in memory 114. Referring back to FIGS. 4A-4U, each of the bit sequences corresponds to respective set of modulation rate and coding scheme of PHR2 and/or data payload of a data packet.

At step 504, a set of information bits corresponding to a first part of the set of modulated data is received. The set of information bits indicate a modulation rate and a coding scheme of a second part of the set of modulated data. Referring back to FIGS. 2B and 2C, the transmitter may receive information bits corresponding to PHR1. The information bits indicate a modulation rate and a coding scheme of PHR2.

At step 506, the modulation rate and coding scheme of the second part of the set of modulated data is mapped to one of the plurality of bit sequences. Referring back to FIGS. 2C and 4A-4U, the transmitter may map the modulation rate and coding scheme of PHR2, indicated by the information bits, to one of the bit sequences in the set.

At step 508, a mapped bit sequence is transmitted as the first part of the set of modulated data. Referring back to FIG. 1, the transmitter may transmit the mapped bit sequence as PHR1, e.g., in signals 118.

FIG. 5B is a flowchart of another method 501 for a transmitter (e.g., a UWB device) to implement the encoding and transmission of PHR1 in a communication system, according to some embodiments of the present disclosure. Method 501 is merely an example, and is not intended to limit the present disclosure beyond what is explicitly recited in the claims. Additional operations can be provided before, during, and after the method 501, and some operations described can be replaced, eliminated, or moved around for additional embodiments of method 501. For ease of illustration, FIG. 5B is described in connection with FIGS. 1, 2A-2C, and 4A-4U.

At step 503, a set of information bits are received corresponding to a modulation rate and a coding scheme of a set of modulated data. Referring back to FIGS. 2B and 2C, the transmitter may receive information bits corresponding to PHR1. The information bits indicate a modulation rate and a coding scheme of PHR2 and/or data payload of a data packet.

At step 505, the modulation rate and coding scheme of the set of modulated data are mapped to one of a plurality of bit sequences. Referring back to FIGS. 2C and 4A-4U, the transmitter may map the modulation rate and coding scheme of PHR2 and/or data payload, indicated by the information bits, to one of the bit sequences in the set, the plurality of bit sequence includes one of: 1 1 1 1 1 1 1 1 1 1 1 1 1 1 1 1 1, 0 0 0 0 0 1 0 0 1 1 0 0 1 1 0 0 1 1 0 0, 0 0 0 0 0 0 0 1 1 0 0 1 1 0 0 1 1 0 0 1, 0 0 0 0 0 1 1 1 0 0 0 0 1 1 1 1 0 0 0 0, 0 0 0 0 0 0 1 0 0 1 0 1 1 0 1 0 0 1 0 1, 0 0 0 0 0 1 0 0 0 0 1 1 1 1 0 0 0 0 1 1, 0 0 0 0 0 0 0 1 0 1 1 0 1 0 0 1 0 1 1 0, 0 0 0 0 0 1 1 1 1 1 1 1 0 0 0 0 0 0 0 0, 0 0 0 0 0 0 1 0 1 0 1 0 0 1 0 1 0 1 0 1, 0 0 0 0 0 1 0 0 1 1 0 0 0 0 1 1 0 0 1 1, 1 1 1 1 1 0 0 0 0 0 0 0 0 0 0 0 0 0 0 0, 0 0 0 0 0 0 0 1 1 0 0 1 0 1 1 0 0 1 1 0, 0 0 0 0 0 1 1 1 0 0 0 0 0 0 0 0 1 1 1 1, 0 0 0 0 0 0 1 0 0 1 0 1 0 1 0 1 1 0 1 0, 0 0 0 0 0 1 0 0 0 0 1 1 0 0 1 1 1 1 0 0, or 0 0 0 0 0 0 0 1 0 1 1 0 0 1 1 0 1 0 0 1.

At step 507, a mapped bit sequence is transmitted as a first part of the set of modulated data. Referring back to FIG. 1, the transmitter may transmit the mapped bit sequence as PHR1, e.g., in signals 118.

FIG. 5C is a flowchart of another method 510 for a receiver device (e.g., a UWB device) to implement the decoding and reception of PHR1 in a communication system, according to some embodiments of the present disclosure. Method 510 is merely an example, and is not intended to limit the present disclosure beyond what is explicitly recited in the claims. Additional operations can be provided before, during, and after the method 510, and some operations described can be replaced, eliminated, or moved around for additional embodiments of method 510. For ease of illustration, FIG. 5B is described in connection with FIGS. 1, 2A-2C, and 4A-4U.

At step 511, a plurality of bit sequences of non-uniform Hamming distance is stored. The plurality of bit sequences each corresponds to a respective set of modulation rate and coding scheme for transmitting a set of modulated data. Referring back to FIG. 1, the receiver (e.g., second device 106) may store a set of bit sequences in its memory. Referring back to FIGS. 4A-4U, each of the bit sequences corresponds to respective set of modulation rate and coding scheme of PHR2 and/or data payload of a data packet.

At step 513, a first part of the set of modulated data is received. The first part of the set of modulated data includes a sample sequence that indicates a modulation rate and coding scheme of a second part of set of modulated data. Referring back to FIGS. 1 and 2A-2C, PHR1, e.g., in the form of a sample sequence of pulse combinations, may be received by the receiver in signals 118. PHR1 may indicate a modulation rate and coding scheme of PHR2.

At step 515, the first part of the set of modulated data is decoded. Referring back to FIG. 2A-2C, the receiver may decode the PHR1. To decode the first part of the set of modulated data, one of the plurality of bit sequences that corresponds to the sample sequence is selected. The receiver may select a bit sequence that corresponds to the received sample sequence. The modulation rate and coding scheme of the second part of the set of modulated data is determined to be a modulation rate indicated by a mapped bit sequence. The receiver may determine the modulation rate and/or coding scheme indicated by the bit sequence.

Those skilled in the art will recognize improvements and modifications to the preferred embodiments of the present disclosure. All such improvements and modifications are considered within the scope of the concepts disclosed herein and the claims that follow.

1. A method for processing a data packet in wireless communication, comprising:
storing a plurality of bit sequences having non-uniform Hamming distances to other bit sequences, the plurality of bit sequences each corresponding to a respective set of modulation rate and coding scheme for transmitting a set of modulated data;
receiving a set of information bits corresponding to a first part of the set of modulated data, the set of information bits indicating a modulation rate and a coding scheme of a second part of the set of modulated data;
mapping the modulation rate and coding scheme of the second part of the set of modulated data to one of the plurality of bit sequences; and
transmitting a mapped bit sequence as the first part of the set of modulated data.

2. The method of claim 1, further comprising transmitting the second part of the set of modulated data at the respective modulation rate and coding scheme indicated by the mapped bit sequence.

3. The method of claim 1, wherein the first part of the set of modulated data comprises a first part of a physical layer header (PHR1).

4. The method of claim 1, wherein the second part of the set of modulated data comprises one of a second part of a physical layer header (PHR2), or a data payload.

5. The method of claim 1, wherein the non-uniform Hamming distance corresponds to a coding strength of the mapped bit sequence from the plurality of bit sequences and is related to a minimum of Hamming distances between the mapped bit sequence and remaining bit sequences of the plurality of bit sequences.

6. The method of claim 1, wherein a first minimum Hamming distance of a first bit sequence is different than a second minimum Hamming distance of a second bit sequence, of the plurality of bit sequences.

7. The method of claim 6, wherein the first minimum Hamming distance of the first bit sequence is at least 13.

8. The method of claim 6, wherein the second minimum Hamming distance of the second bit sequence is at least 8.

9. The method of claim 6, wherein the modulation rate of the second part of the set of modulated data indicated by the first bit sequence is lower than or equal to modulation rates indicated by the second bit sequence.

10. The method of claim 1, wherein the plurality of bit sequences comprise:
1 1 1 1 1 1 1 1 1 1 1 1 1 1 1 1 1 1 1 1,
0 0 0 0 0 1 0 0 1 1 0 0 1 1 0 0 1 1 0 0,
0 0 0 0 0 0 0 1 1 0 0 1 1 0 0 1 1 0 0 1,
0 0 0 0 0 1 1 1 0 0 0 0 1 1 1 1 0 0 0 0,
0 0 0 0 0 0 1 0 0 1 0 1 1 0 1 0 0 1 0 1,
0 0 0 0 0 1 0 0 0 0 1 1 1 1 0 0 0 0 1 1,
0 0 0 0 0 0 0 1 0 1 1 0 1 0 0 1 0 1 1 0,
0 0 0 0 0 1 1 1 1 1 1 1 0 0 0 0 0 0 0 0,
0 0 0 0 0 0 1 0 1 0 1 0 0 1 0 1 0 1 0 1,
0 0 0 0 0 1 0 0 1 1 0 0 0 0 1 1 0 0 1 1,
1 1 1 1 1 0 0 0 0 0 0 0 0 0 0 0 0 0 0 0,
0 0 0 0 0 0 0 1 1 0 0 1 0 1 1 0 0 1 1 0,
0 0 0 0 0 1 1 1 0 0 0 0 0 0 0 0 1 1 1 1,
0 0 0 0 0 0 1 0 0 1 0 1 0 1 0 1 1 0 1 0,
0 0 0 0 0 1 0 0 0 0 1 1 0 0 1 1 1 1 0 0, or
0 0 0 0 0 0 0 1 0 1 1 0 0 1 1 0 1 0 0 1.

11. The method of claim 10, wherein the plurality of bit sequences are modified by changing an order of the rows of the plurality of bit sequences or changing an order of the columns of the plurality of bit sequences.

12. The method of claim 1, wherein the plurality of bit sequences comprise:
0 0 0 0 0 0 0 0 0 0 0 0 0 0 0 0 0 0 0 0,
1 1 1 1 1 0 1 1 0 0 1 1 0 0 1 1 0 0 1 1,
1 1 1 1 1 1 1 0 0 1 1 0 0 1 1 0 0 1 1 0,
1 1 1 1 1 0 0 0 1 1 1 1 0 0 0 0 1 1 1 1,
1 1 1 1 1 0 1 1 0 1 0 0 1 0 1 1 0 1 0,
1 1 1 1 1 0 1 1 1 1 0 0 0 0 1 1 1 1 0 0,
1 1 1 1 1 0 1 0 0 1 0 1 1 0 1 0 0 1,
1 1 1 1 0 0 0 0 0 0 0 1 1 1 1 1 1 1 1,
1 1 1 1 1 0 1 0 1 0 1 1 0 1 0 1 0 1 0,
1 1 1 1 1 0 1 1 0 0 1 1 1 1 0 0 1 1 0 0,
0 0 0 0 0 1 1 1 1 1 1 1 1 1 1 1 1 1 1 1,
1 1 1 1 1 1 1 0 0 1 1 0 1 0 0 1 1 0 0 1,
1 1 1 1 1 0 0 0 1 1 1 1 1 1 1 1 0 0 0 0,
1 1 1 1 1 1 0 1 1 0 1 0 1 0 1 0 0 1 0 1,
1 1 1 1 1 0 1 1 1 1 0 0 1 1 0 0 0 0 1 1, or
1 1 1 1 1 1 1 0 1 0 0 1 1 0 0 1 0 1 1 0.

13. An ultra-wideband (UWB) device, comprising
a transceiver operable to perform UWB communication;
a memory for storing program instructions and a plurality of bit sequences of non-uniform Hamming distance, each of the plurality of bit sequences corresponding to a set of modulation rate and coding scheme for transmitting a set of modulated data; and
a processor coupled to the transceiver and to the memory, wherein the processor is operable to execute the program instructions, which, when executed by the processor, cause the UWB device to perform the following operations:
storing a plurality of bit sequences of non-uniform Hamming distance from one another, the plurality of bit sequences each corresponding to a respective set of modulation rate and coding scheme for transmitting a set of modulated data;
receiving a set of information bits corresponding to a first part of the set of modulated data, the set of information bits indicating a modulation rate and a coding scheme of a second part of the set of modulated data;
mapping the modulation rate and coding scheme of the second part of the set of modulated data to one of the plurality of bit sequences; and
transmitting a mapped bit sequence as the first part of the set of modulated data.

14. The UWB device of claim 13, further comprising transmitting the second part of the set of modulated data at the respective modulation rate and coding scheme indicated by the mapped bit sequence.

15. The UWB device of claim 13, wherein the first part of the set of modulated data comprises a first part of a physical layer header (PHR1).

16. The UWB device of claim 13, wherein the second part of the set of modulated data comprises one of a second part of a physical layer header (PHR2), or a data payload.

17. The UWB device of claim 13, wherein the non-uniform Hamming distance corresponds to a coding strength of the mapped bit sequence from the plurality of bit sequences and is related to a minimum of Hamming distances between the mapped bit sequence and remaining bit sequences of the plurality of bit sequences.

18. The UWB device of claim 13, wherein a first minimum Hamming distance of a first bit sequence is different than a second minimum Hamming distance of a second bit sequence, of the plurality of bit sequences.

19. The UWB device of claim 18, wherein the first minimum Hamming distance of the first bit sequence is at least 13.

20.-24. (canceled)

25. A method for processing a data packet in wireless communication, comprising:
receiving a set of information bits corresponding to a modulation rate and a coding scheme of a set of modulated data;
mapping the modulation rate and coding scheme of the set of modulated data to one of a plurality of bit sequences; and
transmitting a mapped bit sequence as a first part of the set of modulated data, wherein the plurality of bit sequence comprises:
1 1 1 1 1 1 1 1 1 1 1 1 1 1 1 1 1 1 1 1,
0 0 0 0 0 1 0 0 1 1 0 0 1 1 0 0 1 1 0 0,
0 0 0 0 0 0 0 1 1 0 0 1 1 0 0 1 1 0 0 1,
0 0 0 0 0 1 1 1 0 0 0 0 1 1 1 1 0 0 0 0,
0 0 0 0 0 0 1 0 0 1 0 1 1 0 1 0 0 1 0 1,
0 0 0 0 0 1 0 0 0 0 1 1 1 1 0 0 0 0 1 1,
0 0 0 0 0 0 0 1 0 1 1 0 1 0 0 1 0 1 1 0,
0 0 0 0 0 1 1 1 1 1 1 1 0 0 0 0 0 0 0 0,
0 0 0 0 0 0 1 0 1 0 1 0 0 1 0 1 0 1 0 1,
0 0 0 0 0 1 0 0 1 1 0 0 0 0 1 1 0 0 1 1,
1 1 1 1 1 0 0 0 0 0 0 0 0 0 0 0 0 0 0 0,
0 0 0 0 0 0 0 1 1 0 0 1 0 1 1 0 0 1 1 0,
0 0 0 0 0 1 1 1 0 0 0 0 0 0 0 0 1 1 1 1,
0 0 0 0 0 0 1 0 0 1 0 1 0 1 0 1 1 0 1 0,
0 0 0 0 0 1 0 0 0 0 1 1 0 0 1 1 1 1 0 0, or
0 0 0 0 0 0 0 1 0 1 1 0 0 1 1 0 1 0 0 1.

26.-49. (canceled)
